(19) United States
(12) Patent Application Publication
(10) Pub. No.: US 2013/0039412 A1
(43) Pub. Date: Feb. 14, 2013

(54) Predictive coding with block shapes derived from a prediction error

(71) Applicants: Matthias Narroschke, Schaafheim (DE); Florian Knicker, Dreieich (DE)

(72) Inventors: Matthias Narroschke, Schaafheim (DE); Florian Knicker, Dreieich (DE)

(73) Assignee: PANASONIC CORPORATION, Osaka (JP)

(21) Appl. No.: 13/642,649

(22) PCT Filed: Apr. 26, 2011
(86) PCT No.: PCT/EP2011/002093

§ 371 Date: Oct. 22, 2012

Related U.S. Application Data
(60) Provisional application No. 61/328,011, filed on Apr. 26, 2010.

(51) Int. Cl. H04N 7/32

(52) U.S. Cl. 375/240.03; 375/240.02; 375/E07.245

(57) ABSTRACT

The present invention relates to block-wise coding and decoding of a video signal including at least two color components. The first component is coded by using prediction and the second component is segmented to different parts used for its coding according to the prediction error.

The present invention relates to a picture encoding/decoding method, apparatus and a program for executing these methods in software. In particular, the present invention relates to a method for derivation of a block division for coding a color.

### BACKGROUND OF THE INVENTION

At present, the majority of standardized video coding algorithms are based on hybrid video coding. Hybrid video coding methods typically combine several different lossless and lossy compression schemes in order to achieve the desired compression gain. Hybrid video coding is also the basis for ITU-T standards (H.26x standards such as H.261, H.263) as well as ISO/IEC standards (MPEG-X standards such as MPEG-1, MPEG-2, and MPEG-4). The most recent and advanced video coding standard is currently the standard denoted as H.264/MPEG-4 advanced video coding (AVC) which is a result of standardization efforts by joint video team (JVT), a joint team of ITU-T and ISO/IEC MPEG groups. This codec is being further developed by Joint Collaborative Team on Video Coding (JCT-VC) under a name High-Efficiency Video Coding (HEVC), aiming, in particular at improvements of efficiency regarding the high-resolution video coding.

A video signal input to an encoder is a sequence of images called frames, each frame being a two-dimensional matrix of pixels. All the above-mentioned standards based on hybrid video coding include subdividing each individual video frame into smaller blocks consisting of a plurality of pixels. The size of the blocks may vary, for instance, in accordance with the content of the image. The way of coding may be typically varied on a per block basis. The largest possible size for such a block varies. For instance in HEVC, it can be e.g. 64×64 pixels. In H.264/MPEG-4 AVC, a macroblock (usually denoting a block of 16×16 pixels) was the basic image element, for which the encoding is performed, with a possibility to further divide it in smaller subblocks to which some of the coding/decoding steps were applied. In HEVC, it is the largest coding unit (LCU).

Typically, the encoding steps of a hybrid video coding include a spatial and/or a temporal prediction. Accordingly, each block to be encoded is first predicted using either the blocks in its spatial neighborhood or blocks from its temporal neighborhood, i.e. from previously encoded video frames. A block of differences between the block to be encoded and its prediction, also called block of prediction residuals, is then calculated. Another encoding step is a transformation of a block of residuals from the spatial (pixel) domain into a frequency domain. The transformation aims at reducing the correlation between the samples of the input block. Further encoding step is quantization of the coefficients resulting from the transform. In this step the actual lossy (irreversible) compression takes place. Usually, the compressed transform coefficient values are further compacted (losslessly compressed) by means of an entropy coding. In addition, side information necessary for reconstruction of the encoded video signal is encoded and provided together with the encoded video signal. This is for example information about the spatial and/or temporal prediction, amount of quantization, etc.

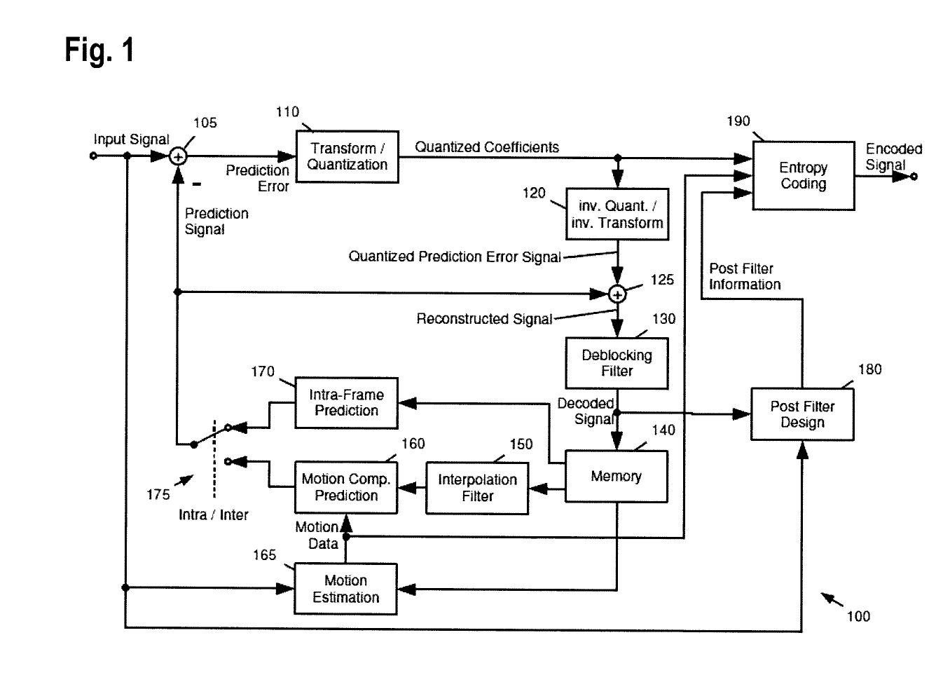

FIG. 1 is an example of a typical H.264/MPEG-4 AVC and/or HEVC video encoder 100. A subtractor 105 first determines differences e between a current block to be encoded of an input video image (input signal s) and a corresponding prediction block ŝ, which is used as a prediction of the current block to be encoded. The prediction signal may be obtained by a temporal or by a spatial prediction 180. The type of prediction can be varied on a per frame basis or on a per block basis. Blocks and/or frames predicted using temporal prediction are called “inter”-encoded and blocks and/or frames predicted using spatial prediction are called “intra”-encoded. Prediction signal using temporal prediction is derived from the previously encoded images, which are stored in a memory. The prediction signal using spatial prediction is derived from the values of boundary pixels in the neighboring blocks, which have been previously encoded, decoded, and stored in the memory. The difference e between the input signal and the prediction signal, denoted prediction error or residual, is transformed 110 resulting in coefficients, which are quantized 120. Entropy encoder 190 is then applied to the quantized coefficients in order to further reduce the amount of data to be stored and/or transmitted in a lossless way. This is mainly achieved by applying a code with code words of variable length wherein the length of a code word is chosen based on the probability of its occurrence.

Within the video encoder 100, a decoding unit is incorporated for obtaining a decoded (reconstructed) video signal s′. In compliance with the encoding steps, the decoding steps include dequantization and inverse transformation 130. The so obtained prediction error signal e′ differs from the original prediction error signal due to the quantization error, called also quantization noise. A reconstructed image signal s′ is then obtained by adding 140 the decoded prediction error signal e′ to the prediction signal ŝ. In order to maintain the compatibility between the encoder side and the decoder side, the prediction signal ŝ is obtained based on the encoded and subsequently decoded video signal which is known at both sides the encoder and the decoder.

Due to the quantization, quantization noise is superposed to the reconstructed video signal. Due to the block-wise coding, the superposed noise often has blocking characteristics, which result, in particular for strong quantization, in visible block boundaries in the decoded image. Such blocking artifacts have a negative effect upon human visual perception. In order to reduce these artifacts, a deblocking filter 150 is applied to every reconstructed image block. The deblocking filter is applied to the reconstructed signal s. For instance, the deblocking filter of H.264/MPEG-4 AVC has the capability of local adaptation. In the case of a high degree of blocking noise, a strong (narrow-band) low pass filter is applied, whereas for a low degree of blocking noise, a weaker (broad-band) low pass filter is applied. The strength of the low pass filter is determined by the prediction signals and by the quantized prediction error signal e′. Deblocking filter generally smoothes the block edges leading to an improved subjective quality of the decoded images. Moreover, since the filtered part of an image is used for the motion compensated prediction of further images, the filtering also reduces the prediction errors, and thus enables improvement of coding efficiency.

After a deblocking filter, an adaptive loop filter 160 may be applied to the image including the already deblocked signal s″. Whereas the deblocking filter improves the subjective quality, ALF aims at improving the pixel-wise fidelity (“objective” quality). In particular, adaptive loop filter (ALF) is used to compensate image distortion caused by the compression. Typically, the adaptive loop filter is a Wiener filter with filter coefficients determined such that the mean square error (MSE) between the reconstructed s′ and source images s is minimized. The coefficients of ALF may be calculated and transmitted on a frame basis. ALF can be applied to the entire frame (image of the video sequence) or to local areas (blocks). An additional side information indicating which areas are to be filtered may be transmitted (block-based, frame-based or quadtree-based).

In order to be decoded, inter-encoded blocks require also storing the previously encoded and subsequently decoded portions of image(s) in the reference frame buffer 170. An inter-encoded block is predicted 180 by employing motion compensated prediction. First, a best-matching block is found for the current block within the previously encoded and decoded video frames by a motion estimator. The best-matching block then becomes a prediction signal and the relative displacement (motion) between the current block and its best match is then signalized as motion data in the form of three-component motion vectors within the side information provided together with the encoded video data. The three components consist of two spatial components and one temporal component. In order to optimize the prediction accuracy, motion vectors may be determined with a spatial sub-pixel resolution e.g. half pixel or quarter pixel resolution. A motion vector with spatial sub-pixel resolution may point to a spatial position within an already decoded frame where no real pixel value is available, i.e. a sub-pixel position. Hence, spatial interpolation of such pixel values is needed in order to perform motion compensated prediction. This may be achieved by an interpolation filter (in FIG. 1 integrated within Prediction block 180).

For both, the intra- and the inter-encoding modes, the differences e between the current input signal and the prediction signal are transformed 110 and quantized 120, resulting in the quantized coefficients. Generally, an orthogonal transformation such as a two-dimensional discrete cosine transformation (DCT) or an integer version thereof is employed since it reduces the correlation of the natural video images efficiently. After the transformation, lower frequency components are usually more important for image quality than high frequency components so that more bits can be spent for coding the low frequency components than the high frequency components. In the entropy coder, the two-dimensional matrix of quantized coefficients is converted into a one-dimensional array. Typically, this conversion is performed by a so-called zig-zag scanning, which starts with the DC-coefficient in the upper left corner of the two-dimensional array and scans the two-dimensional array in a predetermined sequence ending with an AC coefficient in the lower right corner. As the energy is typically concentrated in the left upper part of the two-dimensional matrix of coefficients, corresponding to the lower frequencies, the zig-zag scanning results in an array where usually the last values are zero. This allows for efficient encoding using run-length codes as a part of/before the actual entropy coding.

The H.264/MPEG-4 H.264/MPEG-4 AVC as well as HEVC includes two functional layers, a Video Coding Layer (VCL) and a Network Abstraction Layer (NAL). The VCL provides the encoding functionality as briefly described above. The NAL encapsulates information elements into standardized units called NAL units according to their further application such as transmission over a channel or storing in storage. The information elements are, for instance, the encoded prediction error signal or other information necessary for the decoding of the video signal such as type of prediction, quantization parameter, motion vectors, etc. There are VCL NAL units containing the compressed video data and the related information, as well as non-VCL units encapsulating additional data such as parameter set relating to an entire video sequence, or a Supplemental Enhancement Information (SEI) providing additional information that can be used to improve the decoding performance.

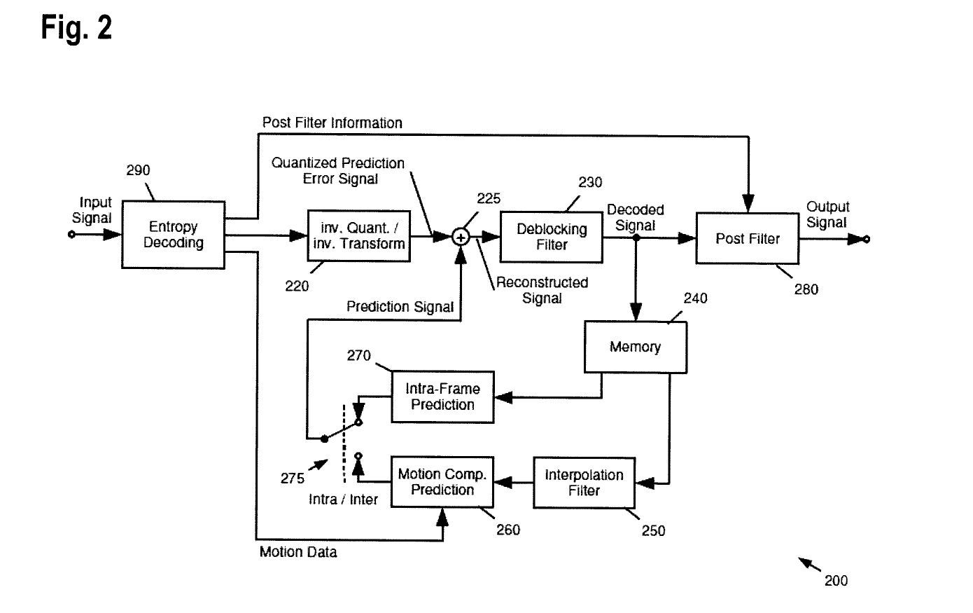

FIG. 2 illustrates an example decoder 200 according to the H.264/MPEG-4 AVC or HEVC video coding standard. The encoded video signal (input signal to the decoder) first passes to entropy decoder 290, which decodes the quantized coefficients, the information elements necessary for decoding such as motion data, mode of prediction etc. The quantized coefficients are inversely scanned in order to obtain a two-dimensional matrix, which is then fed to inverse quantization and inverse transformation 230. After inverse quantization and inverse transformation 230, a decoded (quantized) prediction error signal e′ is obtained, which corresponds to the differences obtained by subtracting the prediction signal from the signal input to the encoder in the case no quantization noise is introduced and no error occurred.

The prediction signal is obtained from either a temporal or a spatial prediction 280. The decoded information elements usually further include the information necessary for the prediction such as prediction type in the case of intra-prediction and motion data in the case of motion compensated prediction. The quantized prediction error signal in the spatial domain is then added with an adder 240 to the prediction signal obtained either from the motion compensated prediction or intra-frame prediction 280. The reconstructed image s′ may be passed through a deblocking filter 250 and an adaptive loop filter 260 and the resulting decoded signal is stored in the memory 270 to be applied for temporal or spatial prediction of the following blocks/images.

Summarizing, standardized hybrid video coders, e.g. H.264/MPEG-4 AVC, are used to code image signals of more than one color component (like YUV, YCbCr, RGB, RGBA, etc). They apply a prediction step 160, 170 and a subsequent prediction error coding step 110. For the purpose of prediction, the current image to be coded is divided into blocks. For each block, either INTRA 170 or INTER 160 prediction is applied. In general, the coding of large prediction errors is associated with a high bit rate; the coding of small prediction errors is associated with a low bit rate. It is possible to use blocks of different sizes. Since the applied block sizes are coded and transmitted, standardized video coders apply rectangular blocks with a minimum block size, e.g. of 4×4 samples.

The degree of freedom according to shape and size of the prediction blocks was chosen as a tradeoff between bit rate required to signal the block division and the prediction accuracy. In several prior art documents, e.g. in
Ken McCann, et al., “Samsung's Response to the Call for Proposals on Video Compression Technology”, document JCTVC-A124, Joint Collaborative Team on Video Coding (JCT-VC) of ITU-T SG16 WP3 and ISO/IEC JTC1/SC29/WG11, 1st Meeting: Dresden, DE, 15-23 Apr. 2010
US 2009/0190659A1
US 2008/0043840A1
US 2008/0008238A1
   it has been shown that it is beneficial to exploit statistical dependencies between the color components for dividing the image into blocks. For instance, the reconstructed samples of one already decoded color component are used to derive block divisions for the subsequent coding of another color component, see JCTVC-A124, chapter 2.4.3. The advantage is that the derivation of block divisions allows arbitrary shapes. Furthermore, no additional bit rate is required to signal the block divisions as they can be derived at the decoder as well as at the encoder in the same way (implicitly).

A general problem underlying the prior art, e.g. H.264/MPEG-4 AVC, is the limitation to rectangular block shapes. The use of arbitrary block shapes increases the prediction accuracy but an explicit coding of the block shapes is associated with a high bit rate. The implicit division into blocks of arbitrary shapes increases prediction accuracy without bit rate increase. However, the implicit block division for a color component to be coded derived from the reconstructed signal of another color component, as used in the above cited prior art may not be accurate or may even be impossible.

### SUMMARY OF THE INVENTION

A specific problem underlying the prior art is that in situations, in which the image content to be coded relates to two objects of different motion, such as an object moving over a static background, an implicit division of the image according to the objects of different motion would be desired for the prediction step. An implicit division derived from the reconstructed signal of an already decoded color component, as done in all prior art, is not possible since
the reconstructed signal does not contain information about the motion of objects, and
the reconstructed signal does not contain information about the boundaries of objects when the objects do not differ with respect to the decoded color component.

Since the implicit block division derived from the reconstructed signal may not be accurate or may even not be possible, the coding efficiency is limited.

It is a particular approach of the present invention to use the prediction error of one already decoded color component to derive block divisions of arbitrary shape for the subsequent coding of another color component or a plurality of components.

The effect of the invention is that the statistical dependencies between the color components for dividing the image into blocks of arbitrary shape may be exploited efficiently.

One of the advantages is that the derivation of block divisions according to the present invention allows arbitrary shapes. Furthermore, in general, no additional bit rate is required to signal the shapes as they can be derived at the decoder as well as at the encoder in the same way. The implicit derivation of the shapes is very accurate since
The prediction error block in combination with the associated displacement vector contains information about the motion of objects.
In situations, in which the image content to be coded relates to two objects of different motion such as an object moving over a static background, an implicit division of the image according to the quantized prediction error is very accurate. In these situations, a prediction can be achieved resulting in prediction errors which are small or even zero.

In particular, according to an aspect of the present invention, a method is provided for encoding at least two color components of a video signal comprising the steps of encoding a block of a first color component using predictive coding and deriving a block division for the encoding of another color component based on the prediction error of said first color component.

According to another aspect of the present invention a method is provided for decoding at least two color components of a video signal comprising a step of decoding of a block of a first color component using predictive coding, deriving a block division for the decoding of another color component based on the prediction error of said first color component.

According to another aspect of the present invention, an encoding apparatus is provided for encoding at least two color components of a video signal, the apparatus comprising an encoding unit for encoding a block of a first color component using predictive coding and a segmentation unit for deriving a block division for the encoding of another color component based on the prediction error of said first color component.

According to another aspect of the present invention, a decoding apparatus comprising a decoding unit operable to decode a block of a first color component using predictive coding; and a deriving unit operable to derive a block division for the decoding of another color component based on the prediction error of said first color component.

The above and other objects and features of the present invention will become more apparent from the following description and preferred embodiments given in conjunction with the accompanying drawings in which:

FIG. 1 is a block diagram illustrating an example of a conventional H.264/MPEG-4 AVC video encoder;

FIG. 2 is a block diagram illustrating an example of a conventional H.264/MPEG-4 AVC video decoder;

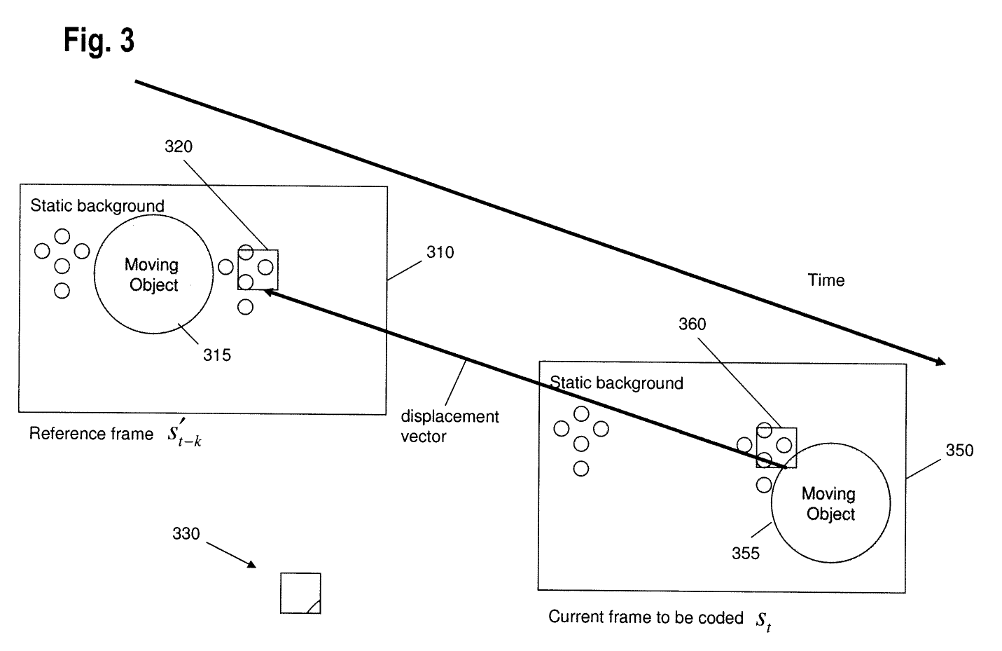

FIG. 3 is a schematic drawing illustrating prediction error of a block-wise temporal prediction;

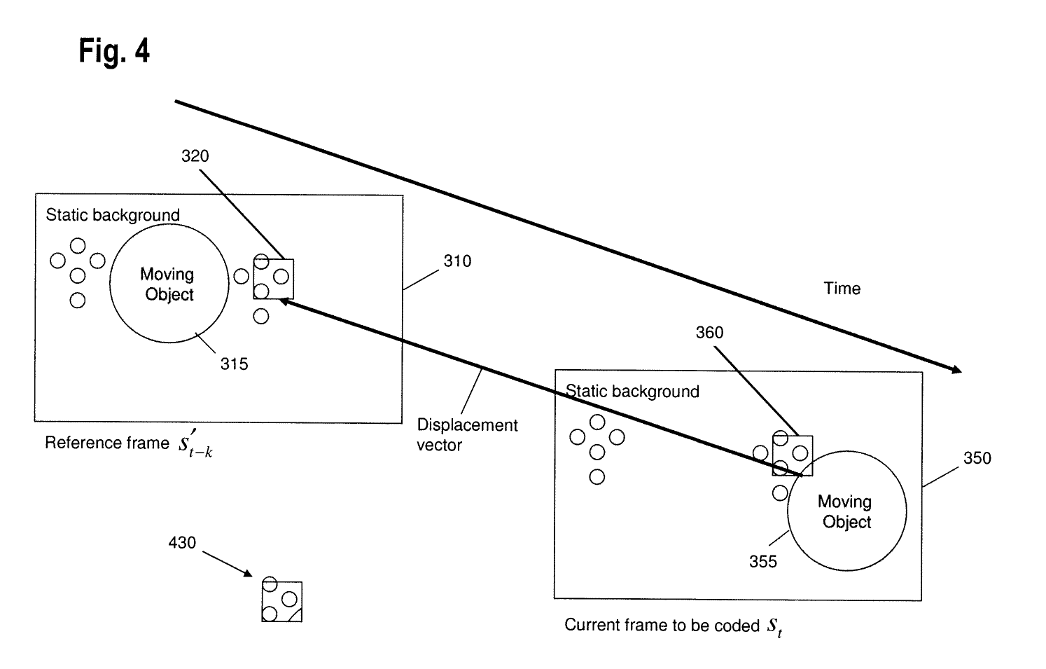

FIG. 4 is a schematic drawing illustrating problems of prior art when determining subdivision of a block of a second component;

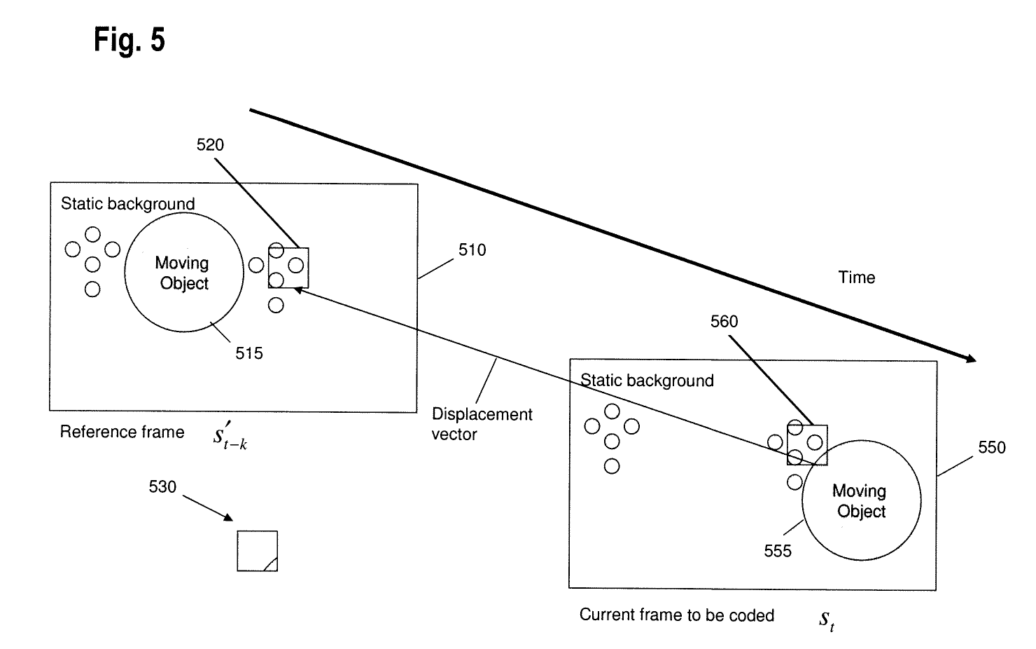

FIG. 5 is a schematic drawing illustrating coding of the first component;

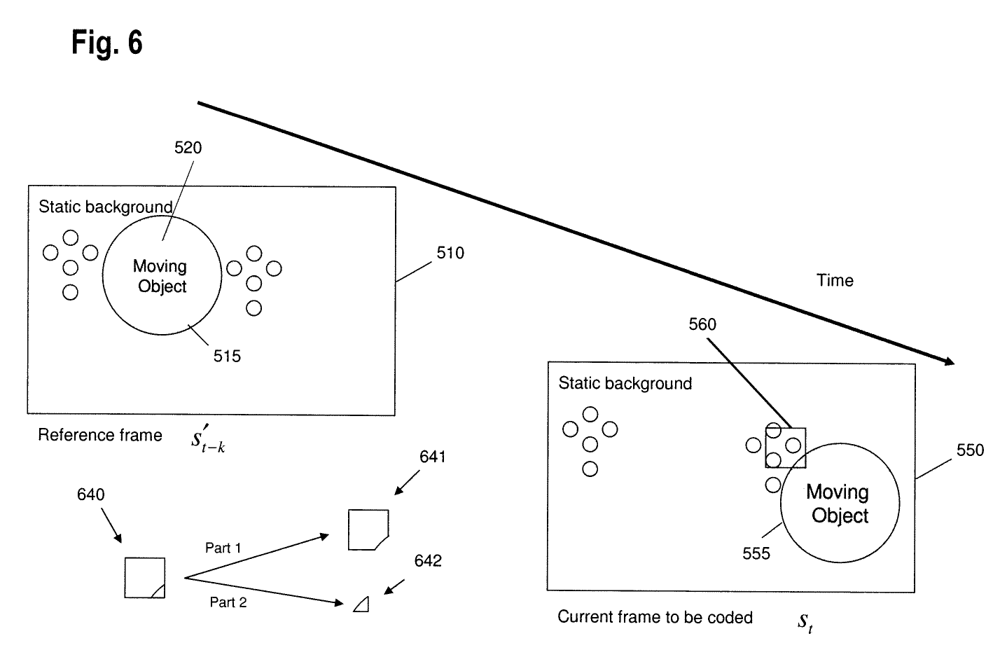

FIG. 6 is a schematic drawing illustrating subdivision of the current block into two parts;

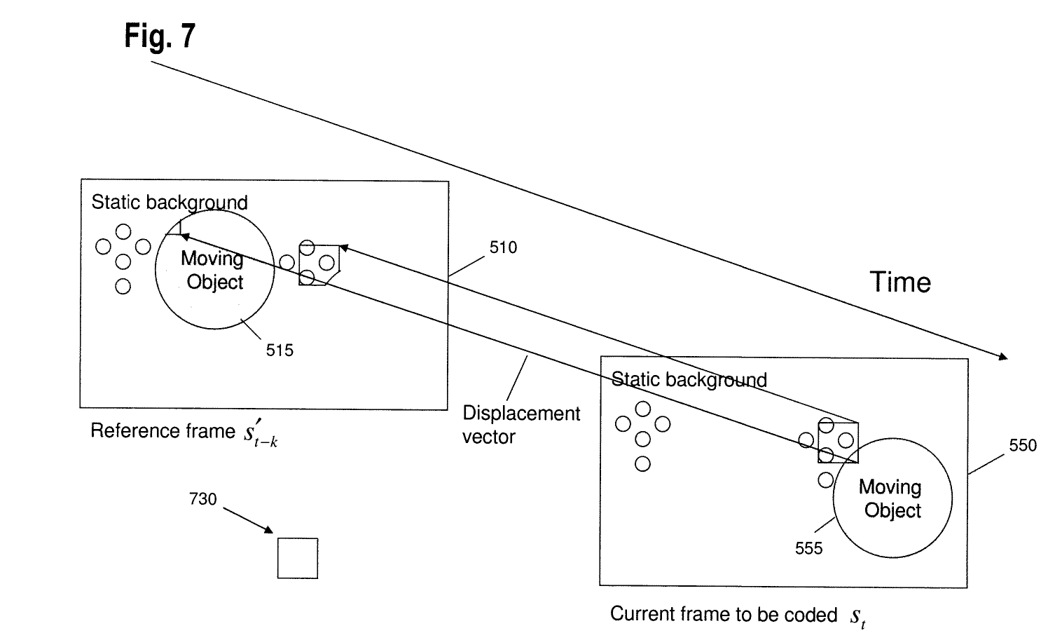

FIG. 7 is a schematic drawing illustrating coding of the second component and a result thereof;

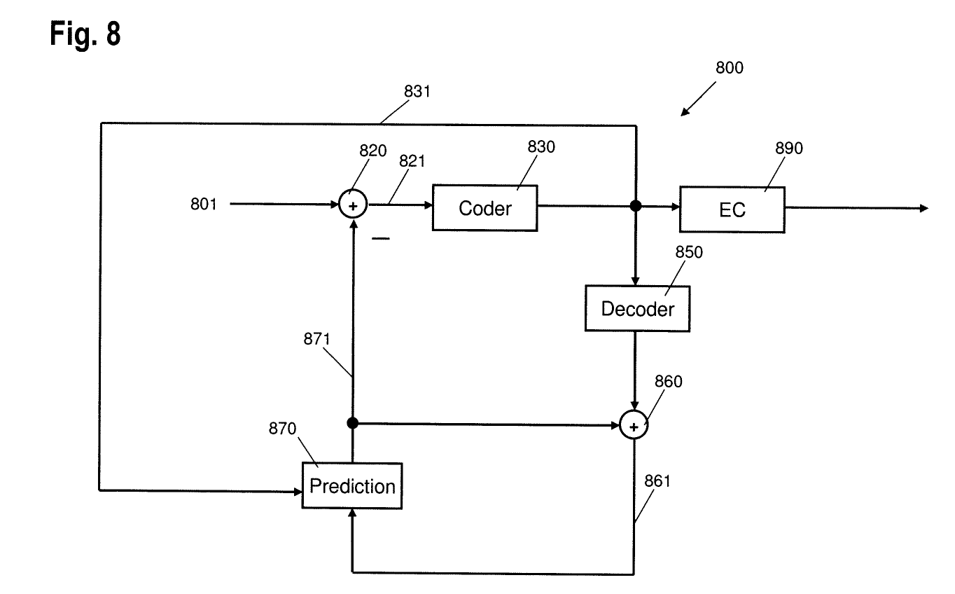

FIG. 8 is a block diagram illustrating an example of an encoder according to a first embodiment of the present invention;

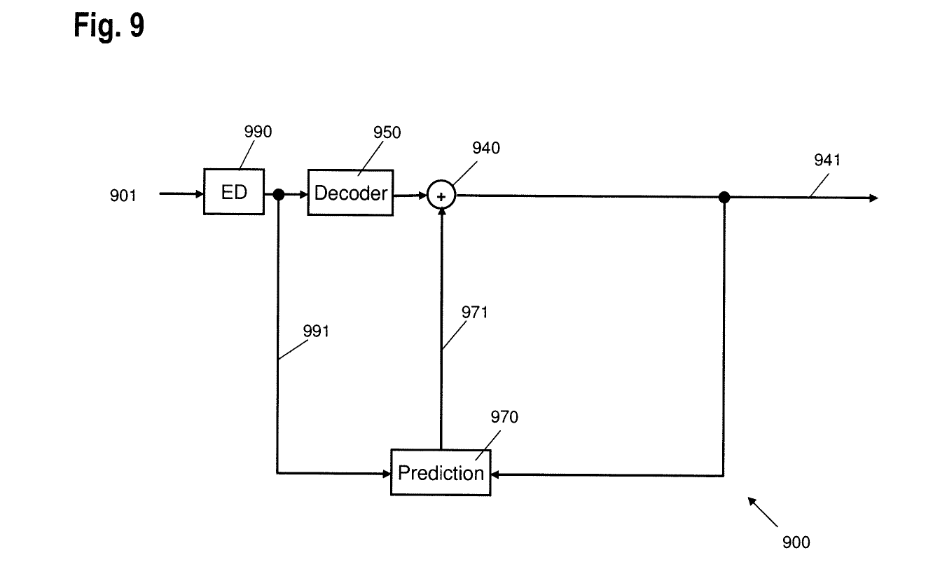

FIG. 9 is a block diagram illustrating an example of a decoder according to a third embodiment of the present invention;

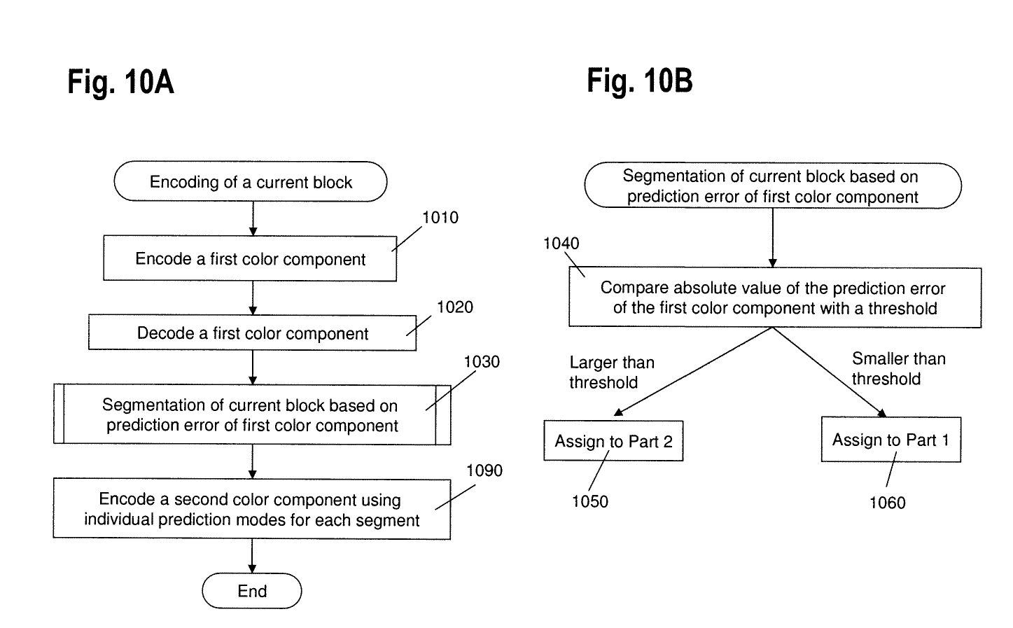

FIG. 10A is a flow diagram illustrating a method for coding a video signal in accordance with the first embodiment of the present invention;

FIG. 10B is a flow diagram illustrating a method for segmenting the image signal into blocks in accordance with the first embodiment of the present invention;

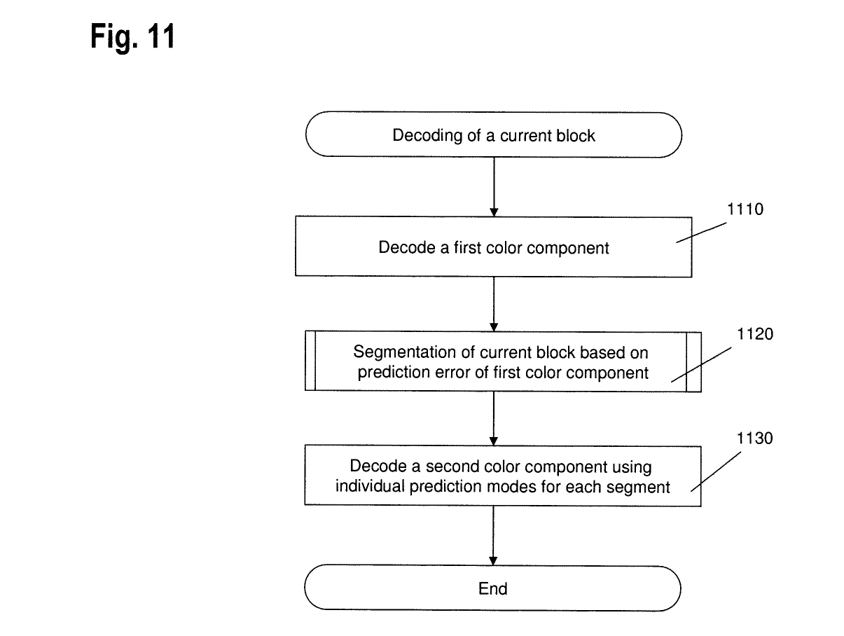

FIG. 11 is a flow diagram illustrating a method for decoding the image signal according to an embodiment of the present invention;

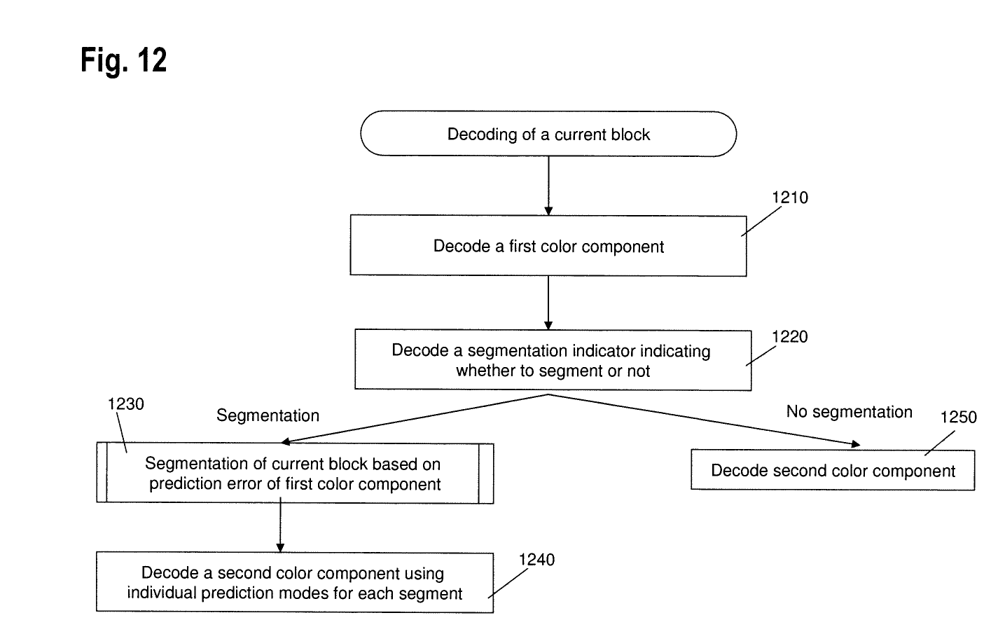

FIG. 12 is a flow diagram illustrating a method for decoding a video signal in accordance with the first embodiment of the present invention;

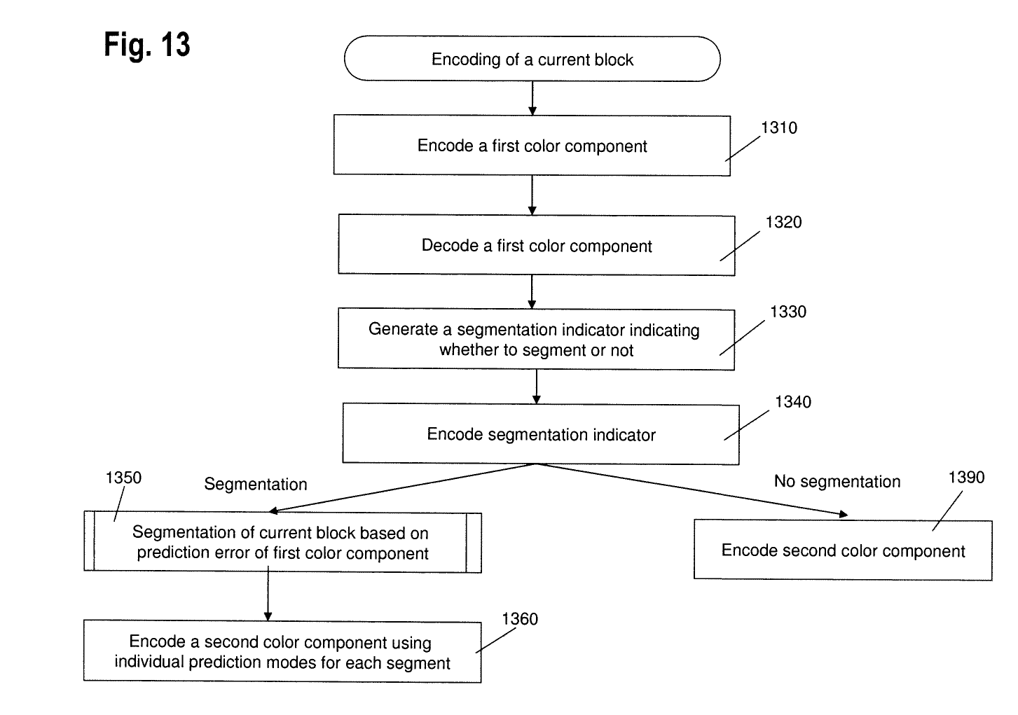

FIG. 13 is a flow diagram illustrating a method for coding a video signal in accordance with the first embodiment of the present invention;

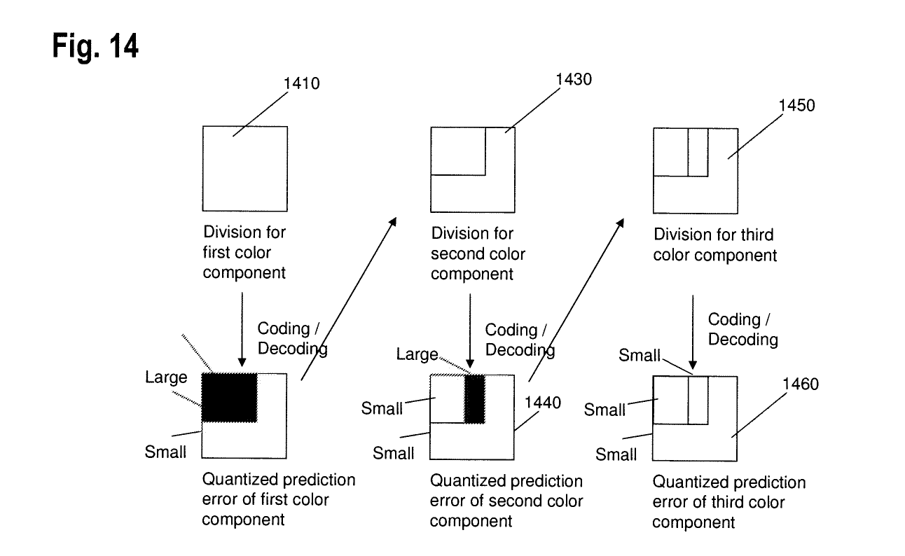

FIG. 14 is a schematic drawing illustrating division of a third-component block to three parts based on the prediction error of the first and the second component;

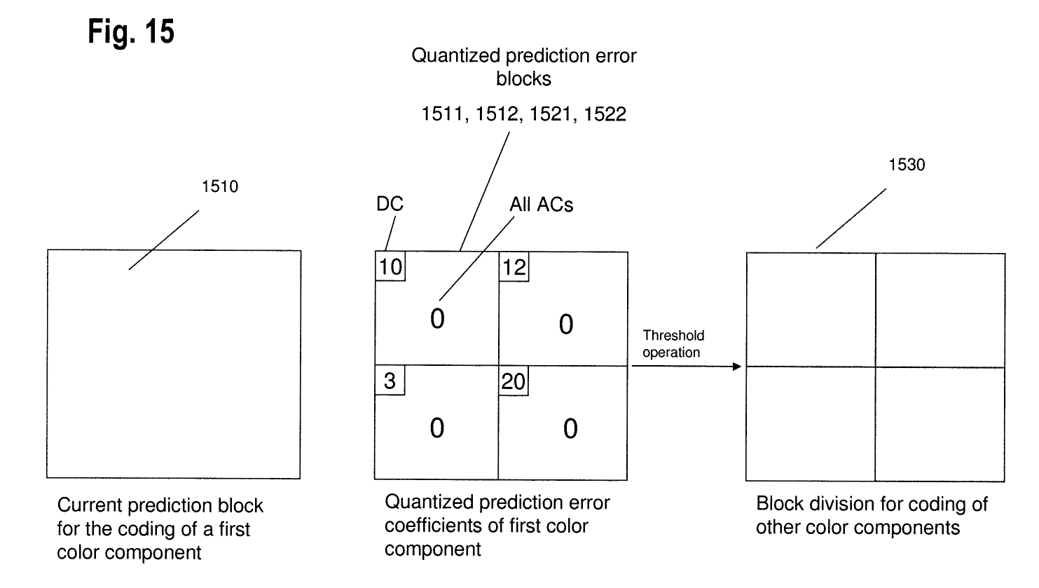

FIG. 15 is a schematic drawing illustrating subdividing the second-component block based on values of DC coefficients of first-component's subblocks;

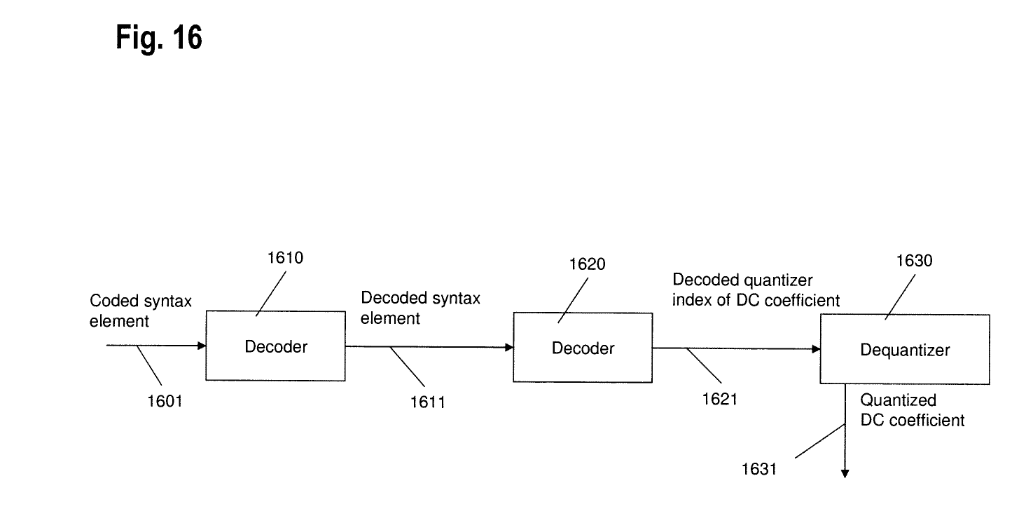

FIG. 16 is a block diagram illustrating decoding of coded DC coefficients;

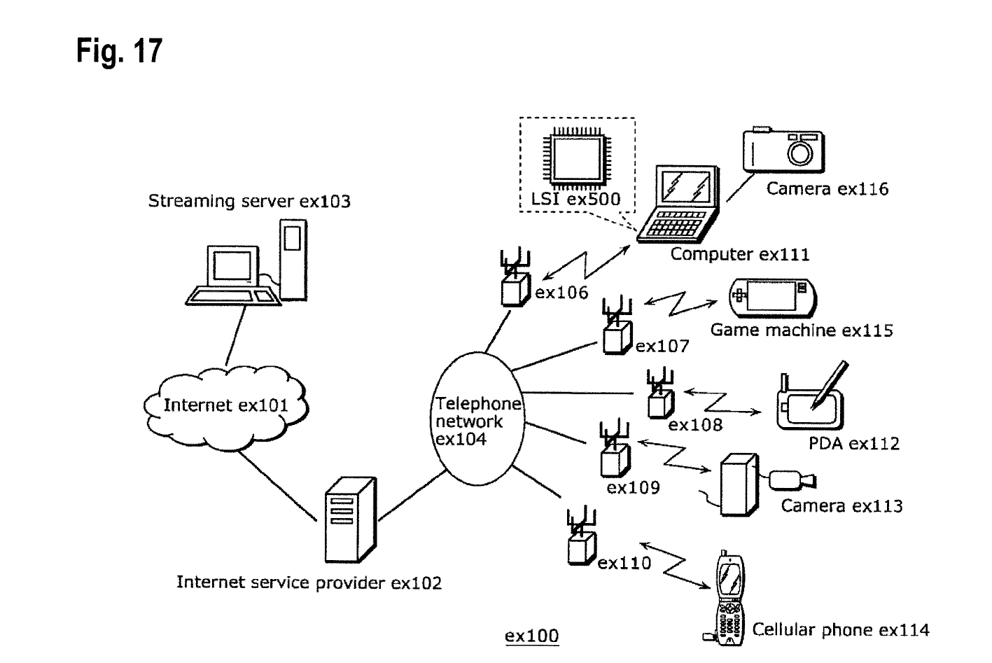

FIG. 17 is a schematic drawing of an overall configuration of a content providing system for implementing content distribution services;

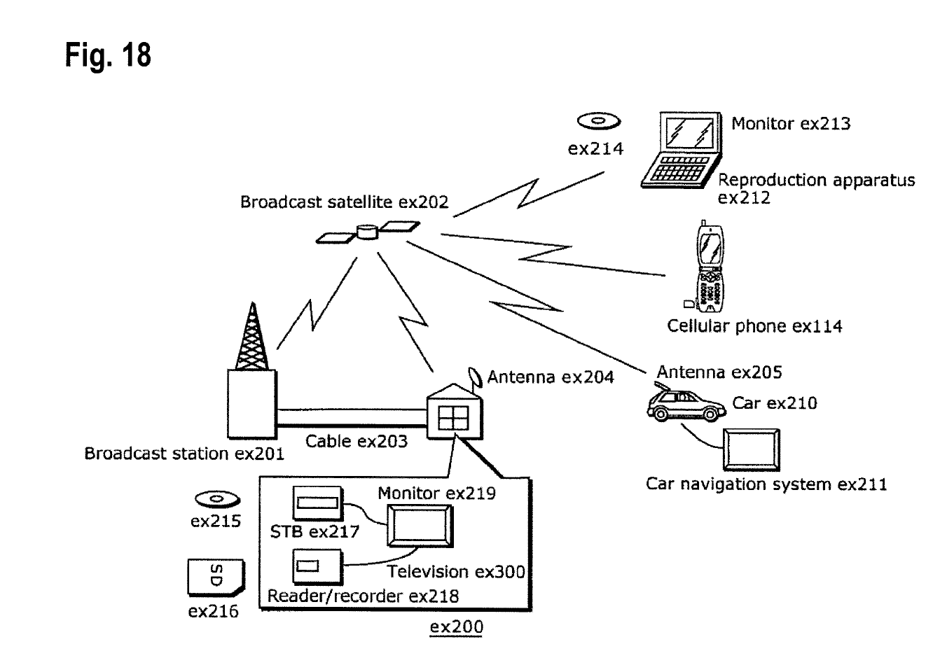

FIG. 18 is a schematic drawing of an overall configuration of a digital broadcasting system;

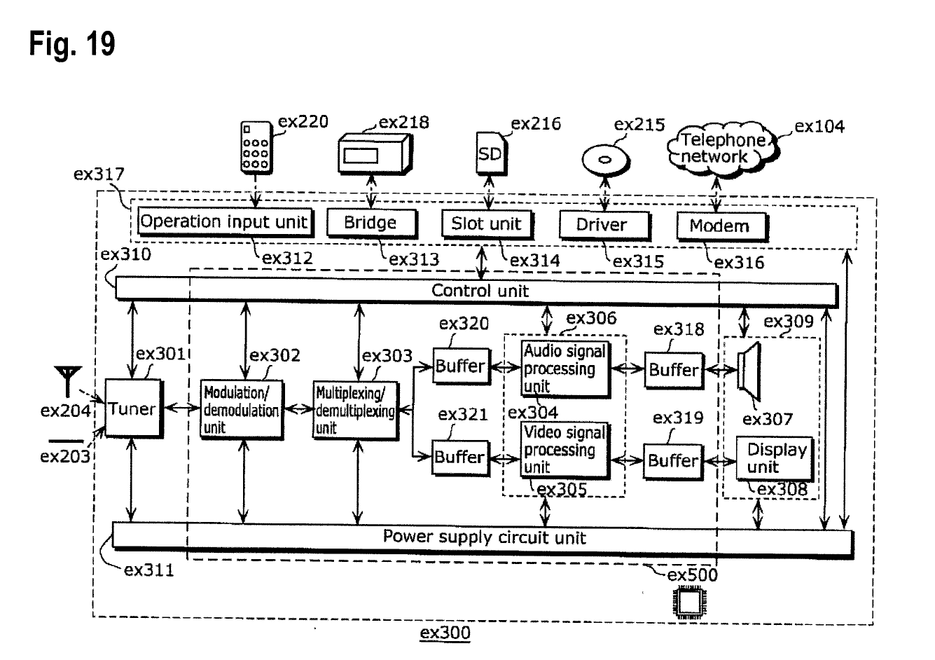

FIG. 19 is a block diagram illustrating an example of a configuration of a television;

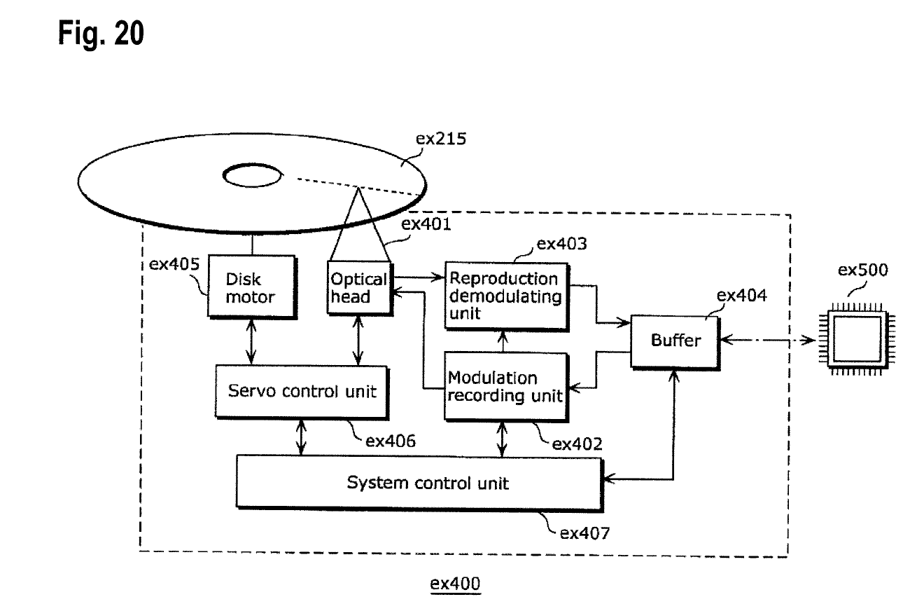

FIG. 20 is a block diagram illustrating an example of a configuration of an information reproducing/recording unit that reads and writes information from or on a recording medium that is an optical disk;

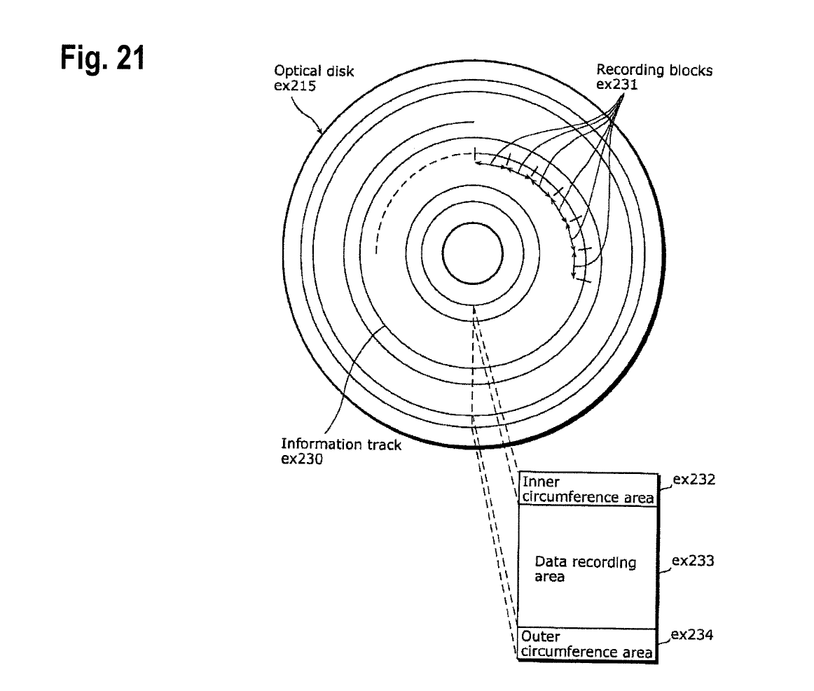

FIG. 21 is a schematic drawing showing an example of a configuration of a recording medium that is an optical disk;

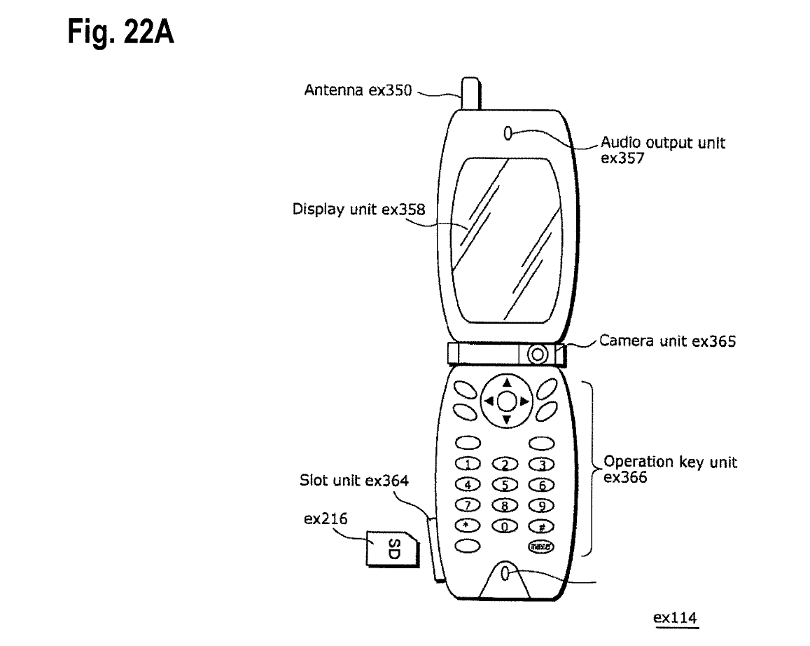

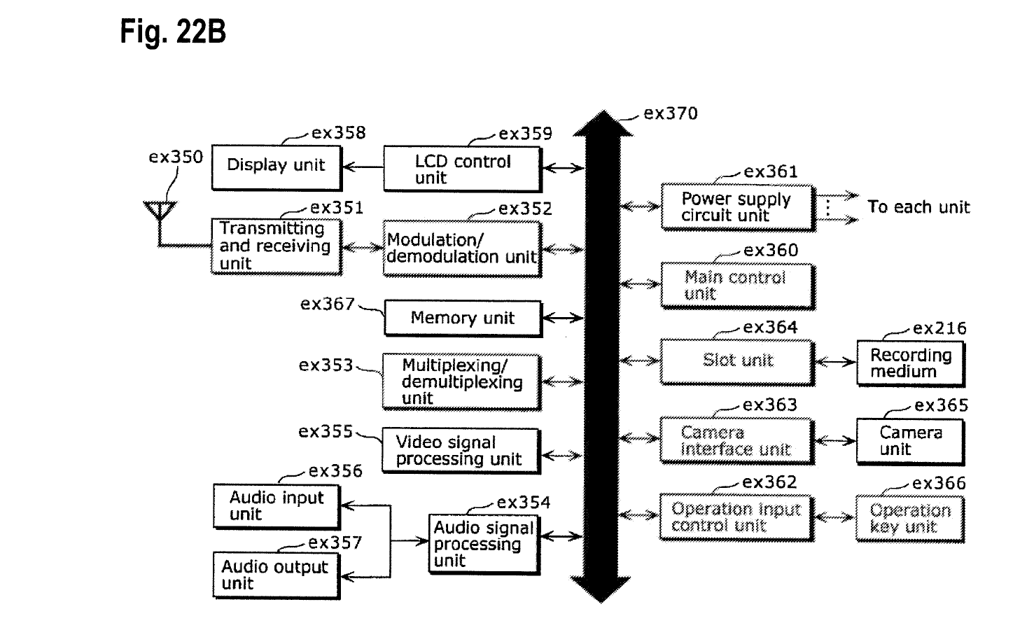

FIG. 22A is a schematic drawing illustrating an example of a cellular phone;

FIG. 22B is a block diagram showing an example of a configuration of the cellular phone;

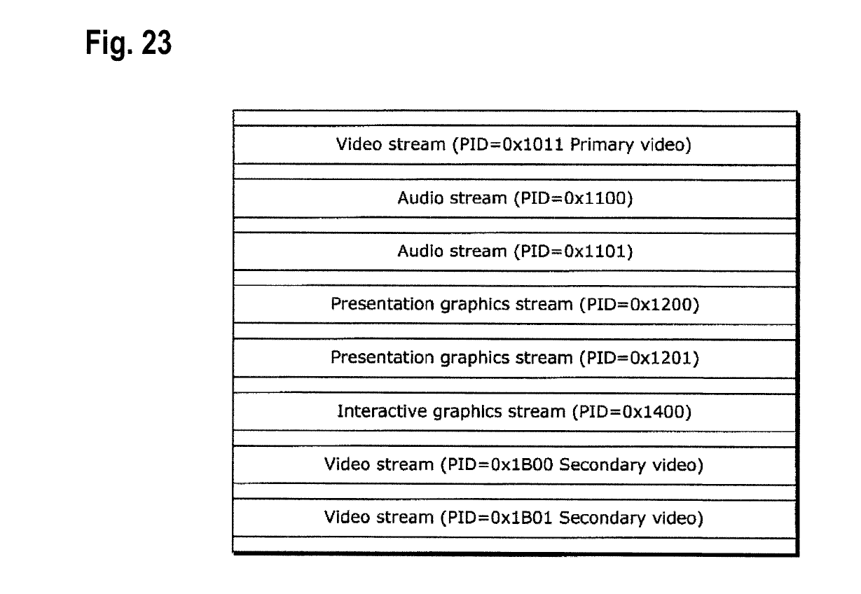

FIG. 23 is a schematic drawing showing a structure of multiplexed data;

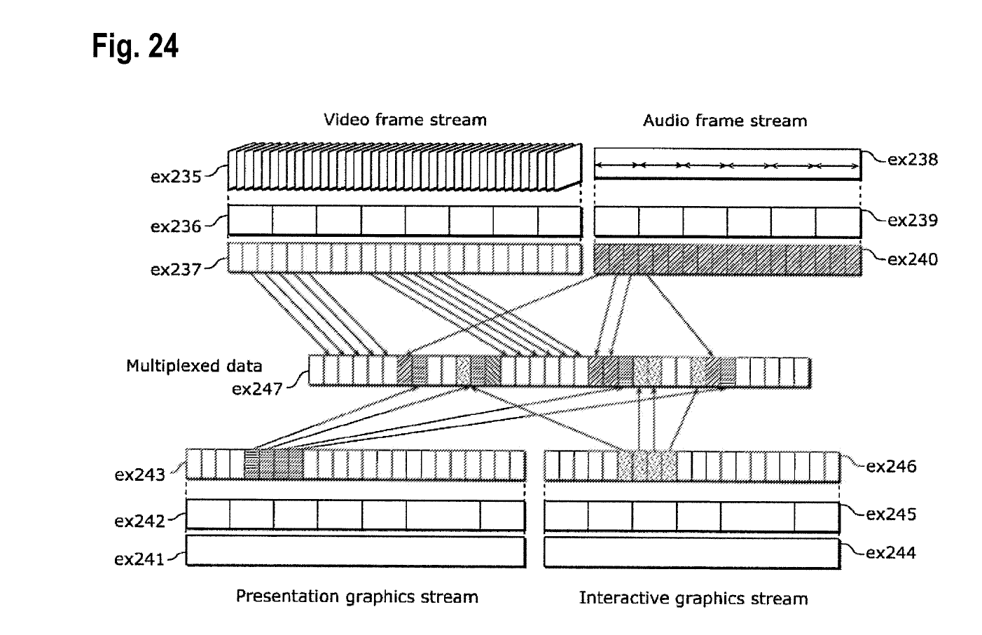

FIG. 24 is a schematic drawing schematically illustrating how each of the streams is multiplexed in multiplexed data;

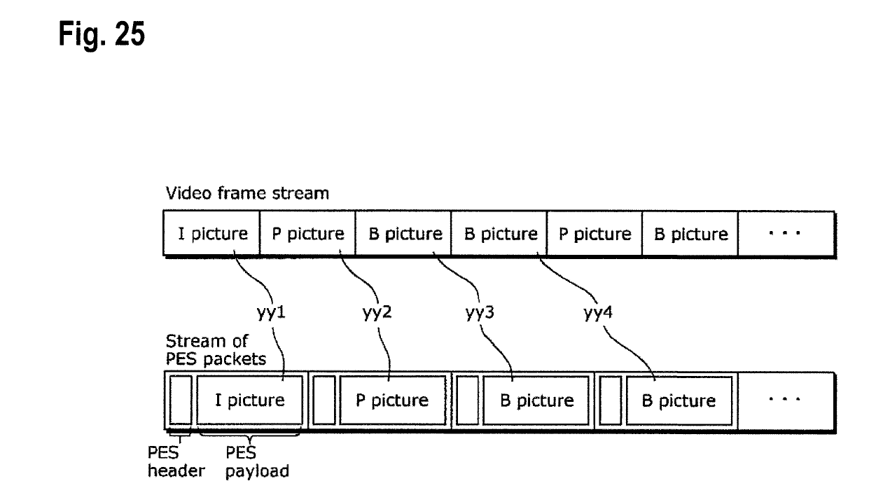

FIG. 25 is a schematic drawing illustrating how a video stream is stored in a stream of PES packets in more detail;

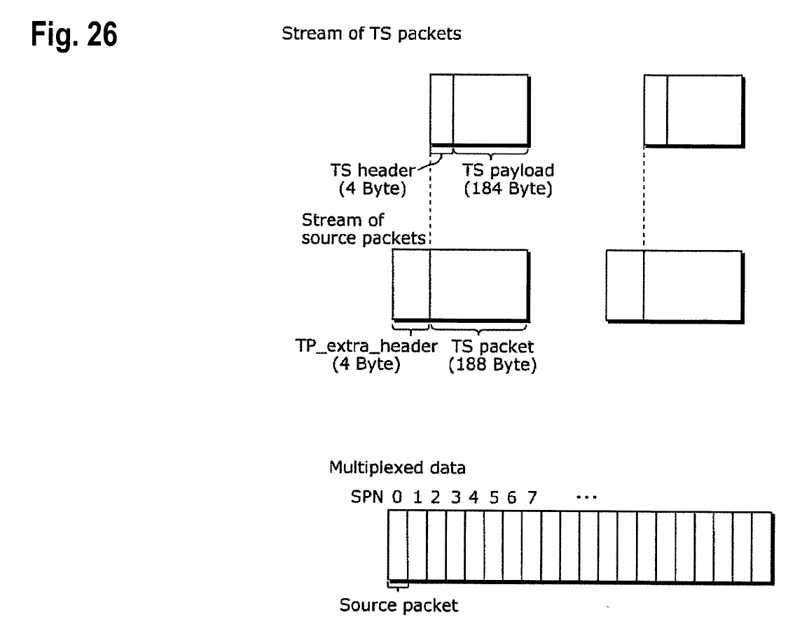

FIG. 26 is a schematic drawing showing a structure of TS packets and source packets in the multiplexed data;

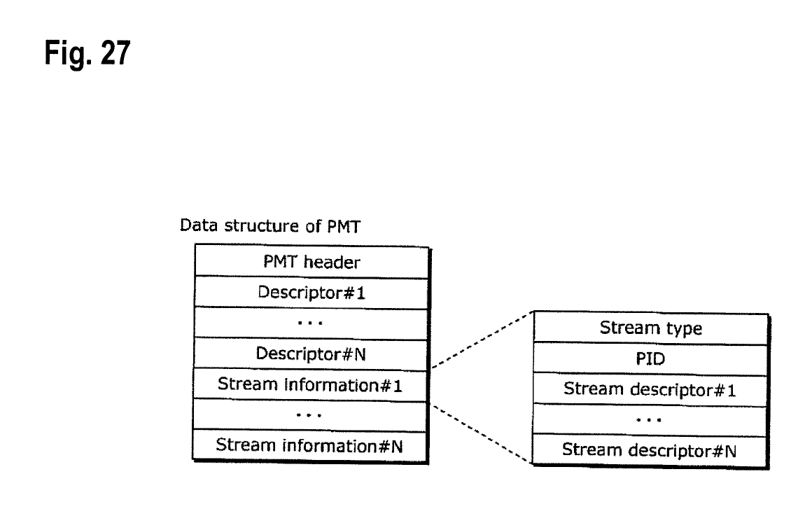

FIG. 27 is a schematic drawing showing a data structure of a PMT;

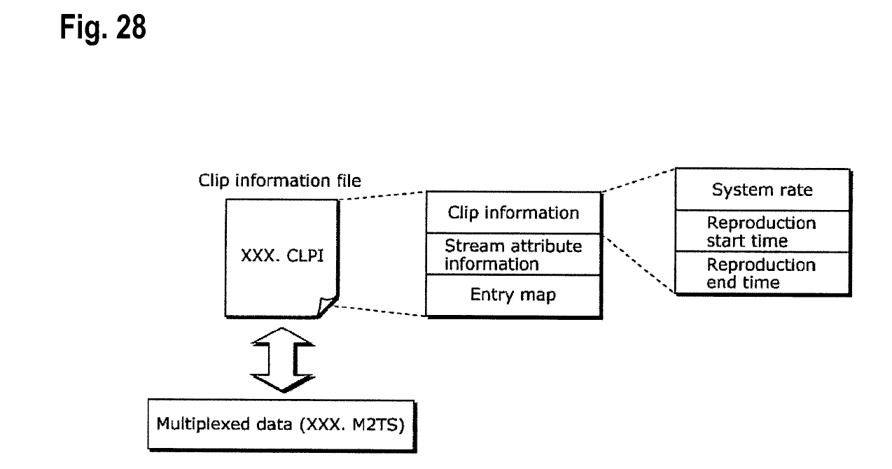

FIG. 28 is a schematic drawing showing an internal structure of multiplexed data information;

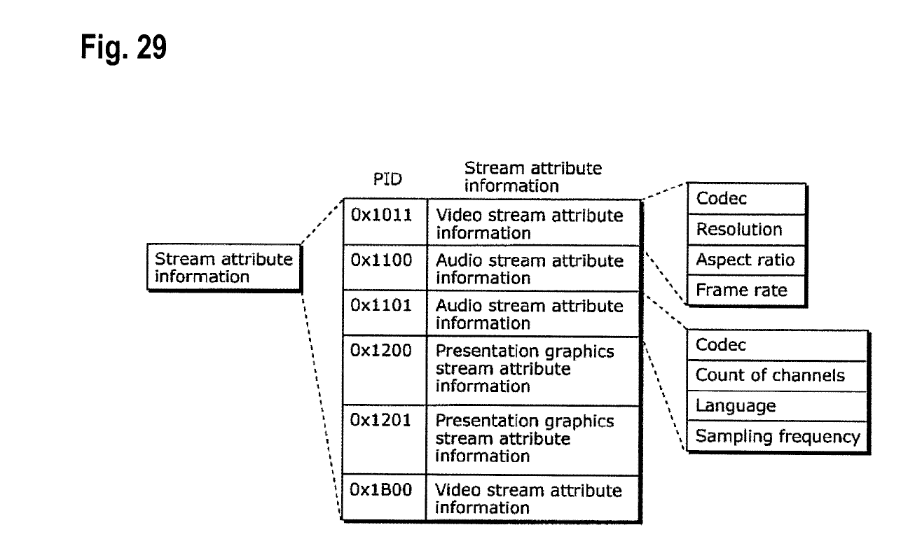

FIG. 29 is a schematic drawing showing an internal structure of stream attribute information;

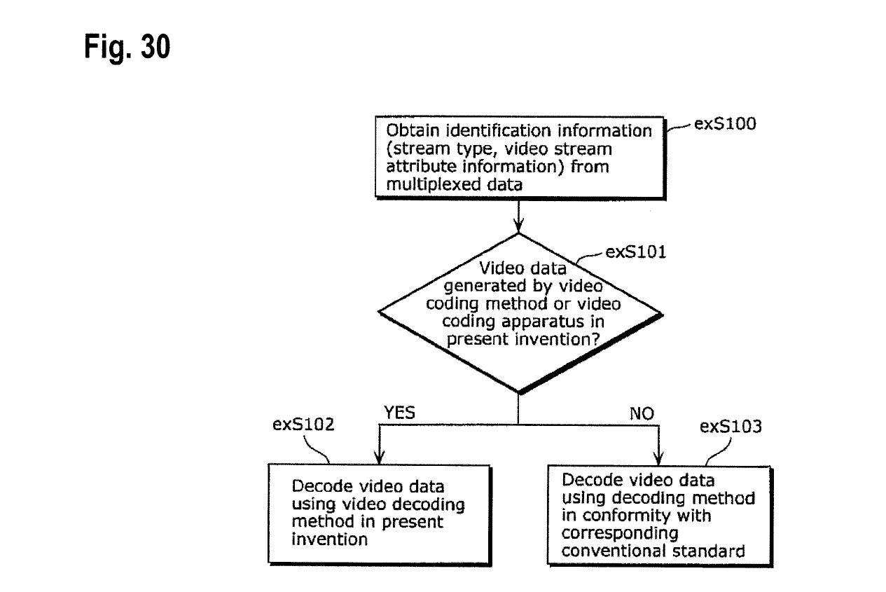

FIG. 30 is a schematic drawing showing steps for identifying video data;

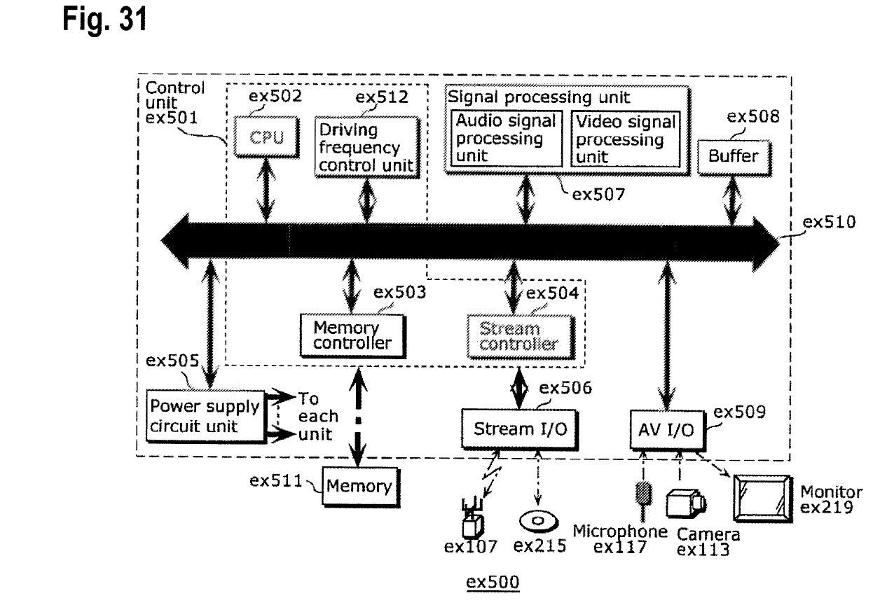

FIG. 31 is a block diagram illustrating an example of a configuration of an integrated circuit for implementing the video coding method and the video decoding method according to each of embodiments;

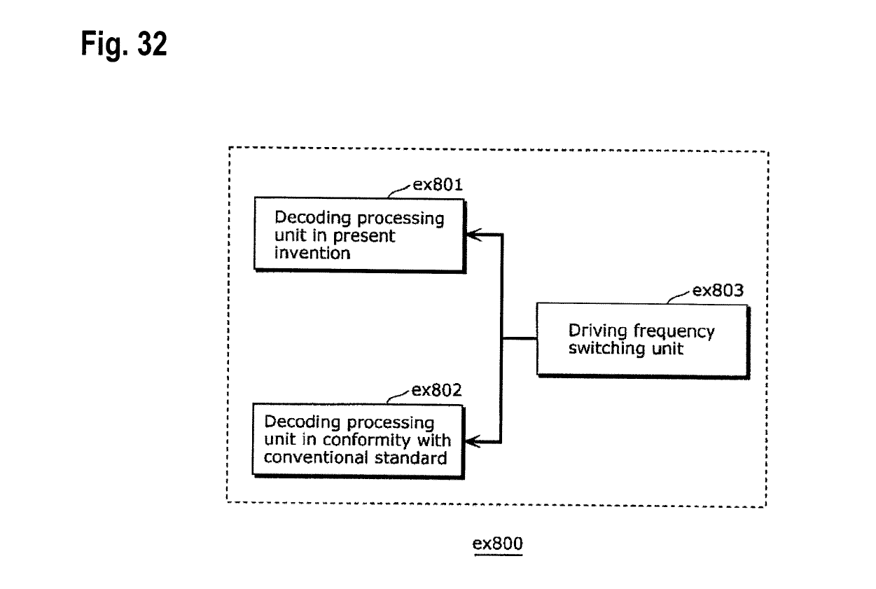

FIG. 32 is a schematic drawing showing a configuration for switching between driving frequencies;

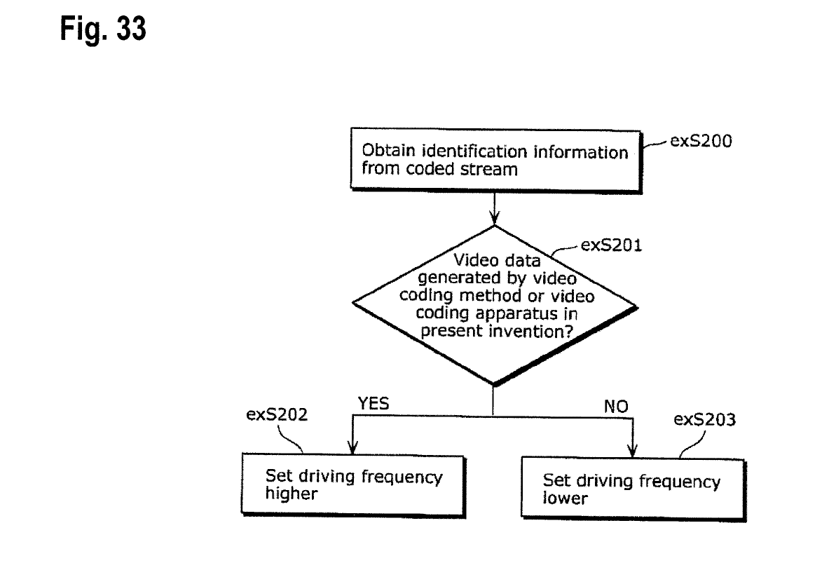

FIG. 33 is a schematic drawing showing steps for identifying video data and switching between driving frequencies;

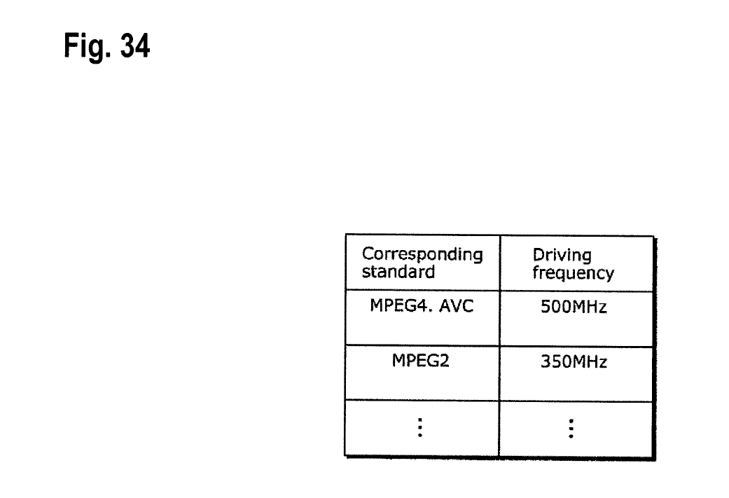

FIG. 34 is a schematic drawing showing an example of a look-up table in which the standards of video data are associated with the driving frequencies;

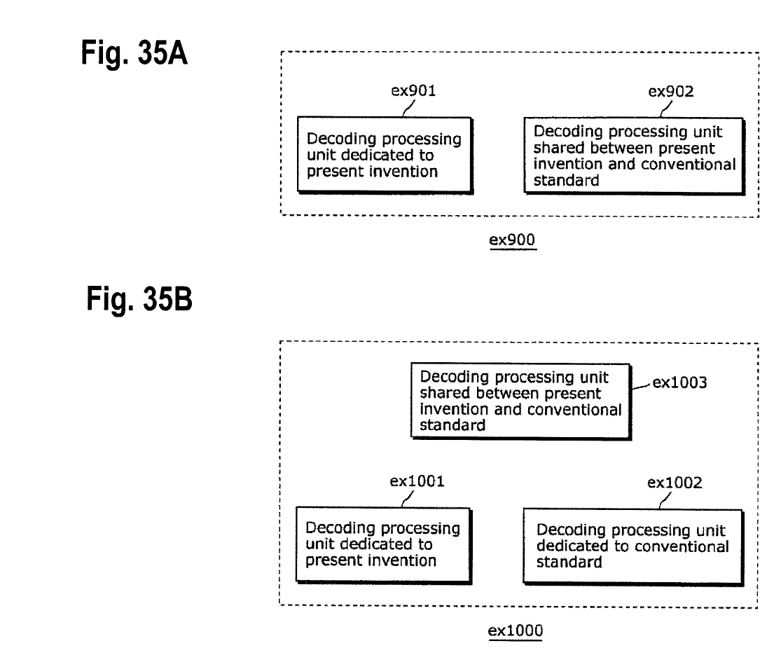

FIG. 35A is a schematic drawing showing an example of a configuration for sharing a module of a signal processing unit; and

FIG. 35B is a schematic drawing showing another example of a configuration for sharing a module of a signal processing unit.

### DETAILED DESCRIPTION OF THE INVENTION

In prior art hybrid video codecs such as H.264/MPEG-4 AVC the block used for prediction are typically of rectangular block shapes. This limits the prediction accuracy, as illustrated in FIG. 3. FIG. 3 shows a reference frame 310 and a current frame 350. The reference frame 310 includes a static background (represented by small filled circles) and a moving object 315 (represented as a bigger filled circle) at a first position. The current frame 350 includes a static background which is on the same position within the current frame 350 as the static background in the reference frame 310. However, the moving object 355 in the current frame 350 is shifted with respect to the moving object within the reference frame 310—there has been a movement of the object between the two frames. When motion estimation is performed for a current block 360 located in the current image 350, the most similar block is searched within the reference frame 310. The search may be performed by a best matching approach or by a selection of a motion vector from a candidate set of motion vectors or by any other motion estimation method. In FIG. 3, the best matching block 320 is identified as a prediction for the current block. In FIG. 3, since the current block 360 mainly includes the portion of a static background and only a small portion of the moving object, the prediction block 320 is selected. Thus, the resulting motion vector (since the background is assumed to be static), is a zero motion vector, meaning that the prediction block 320 is within the reference frame 310 on the same position as the current block 360 within the current frame 350. When the prediction is performed block-wisely, the prediction error block 330 is obtained as a difference between the current block 360 and the prediction block 310. As can be seen in FIG. 1, the prediction error for the current block in the case of rectangular block shape is zero in the part corresponding to the static background. However, the prediction error is high in the bottom right corner, in which in the current block a portion of the moving object 355 is located. The prediction error of such a block thus may be rather large, which then may lead to reductions in coding efficiency.

The use of arbitrary block shapes could increases the prediction accuracy. However, an explicit coding of the block shapes is again associated with an increase of bit rate of the so coded video stream. The implicit division into blocks of arbitrary shapes can increase the prediction accuracy without bit rate increase. However, the implicit block division for a color component to be coded derived from the reconstructed signal of another color component, as known from the prior art, for instance in JCTVC-A124, US20090190659A1, US20080043840A1, or US20080008238A1, may not be accurate or may even not be possible.

This is illustrated in FIG. 4. FIG. 4 shows a case in which the image content to be coded relates to two objects with different motion, namely an object 315, 355 (displayed in two different respective positions) moving over an otherwise static background. An implicit division of the image according to the objects with different motion could be beneficial for the prediction step. However, an implicit division derived from the reconstructed signal of an already decoded color component, as done in all prior art, is not possible since the reconstructed signal does not contain information about the motion of objects, and the reconstructed signal does not contain information about the boundaries of objects when the objects do not differ with respect to the decoded color component. Since the implicit block division derived from the reconstructed signal may not be accurate or may even not be possible, the coding efficiency is also limited. Block 430 represents a reconstructed signal of a first decoded color component. However, based on a single color component of the reconstructed signal, the segmentation of moving object and static background may be inaccurate or even impossible.

In accordance with the present invention, the segmentation of a color component of a frame is based on the prediction error of another color component.

One of the advantages of the present invention is that it also enables division into non-rectangular blocks. However, the present invention is also suitable for a rectangular block subdivision. The present invention also enables implicit determining of the subdivision which prevents further increasing the bit rate of the so coded video signal. However, the present invention may also be combined with signalling of subdivision parameters as will be shown later. The implicit derivation of the shapes according to the present invention is of high accuracy since the prediction error block in combination with the associated displacement vector contains information about the motion of objects, which can be used to derive an appropriate segmentation into blocks. Thus, even in scenarios in which the image content to be coded relates to two objects having different motion (size and/or direction), an implicit division of the image according to the quantized prediction error can be performed leading to an accurate result of prediction (small prediction error).

In the following, example embodiments of the present invention are described. However, the present invention is not limited to these particular embodiments. The embodiments may also be combined with each other.

According to a first embodiment of the present invention, a method is provided in which the prediction error signal is either quantized prediction error signal or quantized and transformed prediction error signal on pixel positions of the block of the first component.

Preferably, the block of the second (another) component, corresponding with position to the block of the first component, is subdivided into two parts according to the thresholding operation result and the two resulting parts are predicted differently.

The image encoding apparatus according to the first embodiment of the present invention consists of a block-based hybrid encoder 800 exemplified in FIG. 8. The color components of the input signal 801 to be encoded may be encoded subsequently. For the purpose of coding, the image is divided into blocks. For each block, a prediction signal is generated by prediction 870, which may be either INTRA prediction or motion-compensated INTER prediction. The prediction error 821, which is the difference from the signal to be coded 801 and the prediction signal 871, is coded using a coder 830 such as a combination of a discrete cosine transform and quantization as shown, for instance in FIG. 1, 110. Furthermore, an entropy coding 890 may be applied. In an internal decoder 850, the coded prediction error is decoded and added 860 to the prediction signal 871 resulting in a reconstructed signal 861. This is stored in a memory for further subsequent prediction steps. In contrast to the above mentioned prior art, the prediction 870 makes use of the quantized prediction error signal 831. This is illustrated in the flow charts of FIGS. 10A and 10B. FIG. 10A illustrates the method according to this invention including the steps of coding 1010 and decoding 1020 of a first color component of a current block to be coded similarly to the prior art systems, such as H.264/MPEG-4 AVC.

Then, for the coding of a subsequent color component of said current block, segmentation is performed based on the decoded prediction error of the first color component.

In particular, an example of segmentation method is illustrated in FIG. 10B, a schematic illustration of the segmentation and its effects is shown in FIGS. 5, 6 and 7. FIG. 5 illustrates the first step of coding a first color component, such as Y component of a YUV signal. Current block 560 of current frame 550 including static background and moving object 555 is predicted by the block 520 in the previous frame 510 also comprising moving object 515, however in another position. Similarly to the coding described with reference to FIG. 3, the prediction error block 530 will have a part with lower and a part with higher prediction error. FIG. 7 illustrates the prediction performed differently for the two parts 641 and 642. In particular, different displacement vectors are found for these separate parts 641 and 642 and thus, their prediction becomes more precise, resulting in lower prediction error 730, in an ideal case to a zero prediction error. The second color component may be, for instance an U and/or V component of an YUV image.

FIG. 6 further shows segmenting the second component block 640, according to which the block 640 may be subdivided into two parts 641, 642, wherein the first part 641 represents an area, in which the absolute value of the prediction error 831 of the first color component is small and the second part 622 represents an area, in which the absolute value of the prediction error of the first color component is large.

As illustrated in FIG. 10B, the segmentation could be done using a threshold operation 1040. In particular, when the absolute value of the prediction error of the first color component is smaller than a threshold value, the component is assigned 1050 to the first part 641. When the absolute value of the prediction error of the first color component is larger than the threshold value, the component is assigned 1060 to the second part 642.

The comparison may be performed based on the quantized prediction error signal. This is advantageous since this signal is available at both encoder and decoder and thus, the derivation of segmentation may be performed implicitly, without necessity for any additional signalling. However, in general, the segmentation of the present invention may also be performed based on the non-quantized prediction error 821. Moreover, the decision may be based on a quantized signal in spatial domain or on a quantized signal in frequency domain, which means after a transformation such as, for instance a DCT.

The threshold value may be predefined in the encoder and in the decoder to have the same value. However, the present invention is not limited thereto and the threshold may also be determined at the encoder, coded, and transmitted to the decoder. The determination may be performed by means of encoder settings by providing a possibility to a user to select it, or automatically by the encoder. Then, the determined threshold may be coded to reduce bitrate necessary for its transmission, for instance by means of an entropy coding.

The determination by the encoder may be performed, for instance, by minimization of the Lagrangian costs of bit rate and mean squared reconstruction error. The threshold could also be determined at the encoder and decoder in the same way based on already decoded symbols. For instance, the decoder could determine the threshold by minimization of the Lagrangian costs of bit rate and mean squared reconstruction error for the image area already decoded. After segmentation 1030, the resulting second-color-component parts 641 and 642 of the block 640 are coded 1090 using different prediction modes. For instance, the first part 641 is encoded with a first prediction mode, preferably the one used for the first color component since it is likely that it results in a low prediction error as in the case of the first color component. Here, the prediction mode means a rule to derive prediction for the part of signal to be predicted. A prediction mode can be, for instance an INTRA prediction mode such as used in H.264/MPEG-4 AVC or an INTRA prediction mode as described in section 2.4.3 of JCTVC-A124. However, the prediction mode may also be an INTER prediction mode for specifying the prediction block as a reference frame index and displacement vector.

Coding of the second part 642 may be performed using a second prediction mode, preferably different from the one used for the first color component since the same prediction mode would likely result in a high prediction error as in the case of the first color component.

An example for block level syntax for INTER coding to include this technique in a video coding standard is shown in the following table:

```
Displacement_vector_color_component_one
Quantized_prediction_error_color_component_one
If (segmentation_indicator) {
  Additional_displacement_vector_color_component_two
  Quantized_prediction_error_color_component_two
  ...
}
```

The “segmentation indicator” may be a setting of an encoder specifying that segmentation is to be used. This may be derived by the encoder and/or decoder or pre-set by a user or fixedly defined in the encoder/decoder.

However, the present invention is not limited thereto and the syntax of the coded video stream may include a segmentation indicator which indicates whether the segmentation according to the present invention is to be applied or not. Such an indicator may advantageously be included, for instance at the sequence, or slice level. However, it may also be included on a block level as will be described below with reference to the second embodiment.

On the block level (cf. the above table), the syntax includes, in case the segmentation is to be applied in accordance with the segmentation indicator, an additional displacement vector for color component two and the corresponding quantized prediction error signal of color component two.

For instance, if the above example described with reference to FIG. 6 is taken, the first part 641 of the current block 640 for which the above syntax element is valid would be encoded in accordance with the displacement vector color component one resulting in quantized prediction error color component one and, in addition, the second part 642 of the current block would be encoded in accordance with the additional displacement vector color component two resulting in quantized prediction error color component two.

It should be noted that the above table only illustrates a portion of the block related syntax to illustrate the features of this embodiment. However, the block-level syntax element may include further elements and/or further color components.

An example for block level syntax for INTRA coding to include this technique in a video coding standard is shown in the following table:

```
Prediction_mode_component_one
Quantized_prediction_error_color_component_one
If (segmentation_indicator) {
  Additional_prediction_mode_color_component_two
  Quantized_prediction_error_color_component_two
  ...
}
```

This table differs from the previous one in that INTRA prediction instead of INTER prediction is applied to both parts of the current block. In particular, prediction mode component one specifies prediction mode for spatial prediction of the first component, wherein this mode is also used to encode the first part 641 of the second color component. The “quantized prediction error color component one” specifies the values of the residual signal. Similar element could be included for the second color component (not shown). In case the segmentation indicator indicates that segmentation is to be applied, an additional prediction mode and residuals are signaled for the second part by “additional prediction mode color component two” and “quantized prediction error color component two” elements.

The above two examples of a block-level syntax portion are not the only possibilities to support the approach of the present invention. In general, this embodiment is not limited to coding both parts 641 and 642 of a current block with either INTER prediction or INTRA prediction. The prediction domain may also differ for the two block parts. For instance, the first color component may be intra coded as well as the first part 641 of the second component as shown in the latter table. However, the second part 642 of the second color component may be predicted temporally as shown in the first table for the case when segmentation indicator indicates that segmentation is to be applied.

The segmentation indicator is advantageously a flag indicating whether a predetermined segmenting is to be applied or not. However, the present invention is not limited thereto and the segmentation indicator may also further indicate the prediction type to be applied (for instance INTRA or INTER) to the second color component. Alternatively, another syntax element may specify type of the prediction. The segmentation indicator may also indicated which color components are segmented and how (based on which other color component(s)).

An image encoding apparatus according to a second embodiment of the present invention comprises a block-based hybrid encoder according to FIG. 6 operating as follows. The color components of the signal to be encoded are encoded subsequently. For the purpose of coding, the image is divided into blocks. For each block, a prediction signal 871 is generated by either INTRA prediction or motion-compensated INTER prediction. The prediction error 821, which is the difference between the signal to be coded 801 and the prediction signal 871, is coded using a coder 830 such as a combination of a discrete cosine transform and quantization, or, possibly, only quantization. Furthermore, an entropy coding 890 is applied. In an internal decoder 850, the coded prediction error 831 is decoded and added to the prediction signal 871 resulting in a reconstructed signal. This is stored in a memory for further subsequent prediction steps. In contrast to the above prior art, the prediction uses the quantized prediction error signal in the following way as also shown in the flow chart in FIG. 13.

FIG. 13 shows the steps of coding 1310 and decoding 1320 of a first color component of a current block to be coded, for instance similarly to prior art systems, such as H.264/MPEG-4 AVC. Then, a step of generating 1330 a segmentation indicator indicating whether to segment a block or not is performed. This may be done, for example, by minimization of the Lagrangian costs of bit rate and reconstruction error.

The segmentation indicator is coded 1340 and transmitted to the decoder. Coding can be performed by fixed length coding or variable length coding. Alternatively, or in addition, a predictive coding can be performed. In particular, the prediction of a segmentation indicator may be based on
a. Segmentation indicators of spatially neighboring blocks, and/or
b. Segmentation indicators of temporally neighboring blocks.

If the segmentation indicator indicates to segment a block, a subsequent color component of said current block is segmented based on the decoded prediction error of the first color component.

One segment is coded using a first prediction mode, preferably the one used for the first color component since it is likely that it results in a low prediction error as in the case of the first color component. A second segment is coded using a second prediction mode, preferably different from the one used for the first color component since the same prediction mode would likely result in a high prediction error as in the case of the first color component.

If the segmentation indicator indicates not to segment the block, a subsequent color component of said current block is coded without segmentation.

An example for block level syntax for INTER coding to include this technique in a video coding standard is shown in the following table

```
Displacement_vector_color_component_one
Quantized_prediction_error_color_component_one
segmentation_indicator
If (segmentation_indicator) {
  Additional_displacement_vector_color_component_two
  Quantized_prediction_error_color_component_two
  ...
}
```

An example for block level syntax for INTRA coding to include this technique in a video coding standard is shown in the following table

```
Prediction_mode_component_one
Quantized_prediction_error_color_component_one
segmentation_indicator
If (segmentation_indicator) {
  Additional_prediction_mode_color_component_two
  Quantized_prediction_error_color_component_two
  ...
}
```

These two tables differ from the tables described within the first embodiment by the segmentation indicator included into the syntax on the block level.

According to a third embodiment of the present invention, an image decoding apparatus is provided, which includes a block-based hybrid decoder as shown in FIG. 7 including the below described units and operating as follows.

The decoding apparatus 900 comprises an entropy decoder 990, a decoding unit (decoder) 950, a predicting unit (predictor) 970, and an adder 940. The color components of the signal 901 to be decoded are decoded subsequently. For the purpose of decoding, the image is divided into blocks. First, an entropy decoding 990 is applied. For each block, the prediction error 941, which is the difference between the signal before the encoding 821 coded and the prediction signal 821, is decoded using a decoder 950 such as a combination of an inverse discrete cosine transform and a scaling operation, or, only the scaling operation. In addition, a prediction signal 971 is generated by a predictor 970 applying either INTRA prediction or motion-compensated INTER prediction by using the transmitted information about prediction modes, motion vectors, etc. The coded prediction error is decoded and added 940 to the prediction signal 970 resulting in a reconstructed signal 941. This is stored in a memory for further subsequent prediction steps. In contrast to the above cited prior art, the prediction uses the quantized prediction error signal 991 in the following way as illustrated also in the flow chart of FIG. 11.

In particular, FIG. 11 shows decoding 1110 of a first color component of a current block to be decoded as in prior art systems, such as H.264/MPEG-4 AVC. For the decoding of a subsequent color component of said current block, segmentation 1120 is performed based on the decoded prediction error of the first color component. One possibility for segmentation is to divide the block into two parts as shown in FIG. 6 already described with respect to the first embodiment.

The first part (Part 1) 641 is an area, in which the absolute value of the prediction error of the first color component is small. The second part (Part 2) 642 is an area, in which the absolute value of the prediction error of the first color component is large.

The segmentation may be performed using a threshold operation:
If the absolute value of the prediction error 991 of the first color component is smaller than a threshold value then the signal is assigned to the first part 641.
If the absolute value of the prediction error 991 of the first color component is larger than a threshold value than the signal is assigned to the second part 642.

The threshold value could be predefined in the encoder and in the decoder. It could also be determined at the encoder and coded and transmitted to the decoder. The threshold could also be determined at the encoder and decoder in the same way based on already decoded symbols.

Regarding the thresholding, the parts of signal equal to the threshold may be assigned either to part one or to part two in a predefined way. The signal here may be represented by particular pixel samples of the second color component. It is noted that for the purposes of prediction either directly the entropy decoded signal representing the prediction error may be used. Alternatively, the decoded prediction error signal may be used (decoding here refers to inverse transformation and/or scaling).

After segmentation 1120, the steps of decoding 1130, in particular, decoding of Part 1 using a first prediction mode and decoding of Part 2 using a second prediction mode are performed.

In accordance with the fourth embodiment of the present invention, a decoding apparatus is provided, which includes a block-based hybrid decoder as already described with reference to FIG. 9 operating as follows: The color components of the signal to be decoded are decoded subsequently. For the purpose of decoding, the image is divided into blocks. First, an entropy decoding 990 is applied. For each block, the prediction error, which is the difference from the signal to be coded and the prediction signal, is decoded using a decoder such as a combination of an inverse discrete cosine transform and a scaling operation. In addition a prediction signal is generated by either INTRA prediction or motion-compensated INTER prediction by using the transmitted information about prediction modes, motion vectors, etc. The coded prediction error is decoded and added to the prediction signal resulting in a reconstructed signal. This is stored in a memory for further subsequent prediction steps. In contrast to the above mentioned prior art, the prediction uses the quantized prediction error signal in the following way as also shown in the flow chart of FIG. 12.

The flow chart of FIG. 12 shows decoding of a first color component of a current block to be decoded as in prior art systems, such as H.264/MPEG-4 AVC. Then the segmentation indicator is decoded 1220. In accordance with the decoded segmentation indicator, the segmentation of the current block is performed.

In particular, if the segmentation indicator indicates to segment a block, a subsequent color component of said current block is segmented 1230 based on the decoded prediction error of the first color component. Then, the second color component is decoded 1240. For instance, the first part 641 is decoded using a first prediction mode and the second part 642 is decoded using a second prediction mode.

On the other hand, If the segmentation indicator indicates not to segment a block, a subsequent color component of said current block is decoded 1250 without segmentation.

According to a fifth embodiment of the present invention, an image encoding and decoding apparatuses are provided, which apply, in addition to the features of the present invention, an upsampling or downsampling step to the quantized prediction error of the first color component before the block division is derived for the subsequent color components. Upsampling is performed in situations, in which a smaller sampling rate has been used for the first color component than for the second or any other color component. Downsampling is performed in situations, in which a larger sampling rate has been used for the first color component than for the second or any other color component. Smaller or larger sampling rates are for example applied in the case of so called 4:2:2 or 4:2:0 sampling.

In accordance with a sixth embodiment of the present invention, an image encoding and decoding apparatuses apply, in addition, a motion vector prediction. In the case that a block division is performed for a current block with inter-prediction, a motion vector prediction can be performed for the second part 642 of the division, where the prediction error is large, and the motion vector can be predicted from the data, e.g. motion vector, of the spatially or temporally neighboring blocks. It is likely that the neighboring block belongs to the same object as the image content the second part 642 of the current block. Therefore it may be assumed to have a similar motion. With this motion vector prediction a further bit rate reduction may be achieved.

In accordance with a seventh embodiment of the present invention, an image encoding and decoding apparatuses are provided, which apply, in addition to the division described above, a further block division.

In this embodiment, the following two steps are preferably performed: coding the two parts of the block of the second color component based on their respective prediction; and deriving a block division for the encoding of a third color component based on the prediction error of said second color component.

In particular, the block division can be extended to use more than one color component as shown in FIG. 14. FIG. 14 shows a current non segmented block 1410. The prediction error of the first component is obtained by coding/decoding resulting in block 1420, in which the black part illustrates a high value of the prediction error and the white part illustrates low values of the prediction error. Accordingly, by means of thresholding, subdivision of a second-component block 1430 is performed and the second component is coded/decoded correspondingly, obtaining block 1440 of error prediction of the second component. In this example, the quantized error prediction block 1440 of the second component still includes a portion with small and a portion with high values. Thus, for the coding of the third component a further subdivision of the second part of the second component into two parts is performed by thresholding, resulting in the third component 1450. Each of the three portions of the third component is predicted individually. For instance, the first portion is encoded in the same way as the first component 1410 and the first part of the second component (with the small prediction error). The second part of the third component is coded in the same manner as the second part of the second component. The third part is coded by using a further prediction mode (a different motion vector and/or a different direction of prediction, and/or different type of prediction). Such coding results in a reduced prediction error of the third component as illustrated by block 1460.

This means for the coding of a current block 1410 of a color component, the quantized prediction error signals of all other color components can be used for block divisions. For example for coding three color components, the first two color components are coded as described in the other embodiments. For the third color component the block is divided into at least three parts. This is done by using the division for the second color component and dividing the second part again into two parts in the same way as it was done initially for the second color component. Separate prediction modes can be used for the at least three parts of the third color component. Thus, the prediction can be improved further resulting in an increased coding efficiency.

According to an eighth embodiment of the present invention, an image encoding and decoding apparatuses are provided which derive a block division based on the coefficients of the quantized prediction error of the first color component.

In particular, the block division is derived based on a threshold operation comparing the prediction error signal with a predetermined threshold. Preferably, the prediction error signal compared is a DC coefficient of subblocks of said block of the first color component transformed into frequency domain. The block of the second component, corresponding with position to the block of the first component, may be subdivided into two parts according to the thresholding operation result; and; the two parts are predicted differently.

This is illustrated in FIG. 15 for the case that only the DC-coefficients are used in order to derive a block division. A block division can be achieved, for instance, by assigning all blocks with DC-coefficient-information below a threshold value to a first part and all blocks with DC-coefficient-information above a threshold value to a second part of image signal. A DC-coefficient-information can be
Quantized DC coefficient 1631 as illustrated in FIG. 16 or
Decoded quantizer index 1621 of DC coefficient as illustrated in FIG. 16.

Furthermore, a block division can be achieved, for instance, by assigning all blocks with DC-code-information equal to a first set of values to a first part and all blocks with DC-code-information equal to a second set of values to a second part. A DC-code-information can be
Decoded syntax element 1611 as illustrated in FIG. 16 or
Coded syntax element 1601 as illustrated in FIG. 16.

The sets of values can be
A set of syntax elements or
A set of code words.

FIG. 16 is a block diagram illustrating decoding of DC coefficients which may be performed on the encoder side or on the decoder side. An encoded syntax element 1601 is formed by a codeword and is decoded by a decoder 1610 (for instance, an entropy decoder) to obtain a decoded syntax element 1611. The decoded syntax element 1611 is further decoded 1620, for instance by parsing the jointly coded elements such as quantizer indices, to obtain a decoded quantizer index 1621 of DC coefficient. The quantizer index 1621 is further decoded 1630 by applying rescaling to obtain quantized DC coefficient. In accordance with a ninth embodiment of the present invention, an image encoding and decoding apparatuses perform a block division as explained in the embodiments one to eight above and, in addition, perform a final decision whether to separate a block or not. This decision is preferably based on the number of samples in each block segment (i.e. Part 1 and Part 2) and based on a threshold value. The benefit is not to use segments with a very small number of samples since the additional bit rate to code another prediction mode for a very small segment is inefficient. This threshold value can either be predefined, or determined at the encoder, and coded and transmitted in the bit stream. It may be advantageous if the number of samples is equal or larger than the number of samples of a smallest regular rectangular prediction block. However, the present invention is not limited thereto and the threshold may take any other values. The determination could be done by minimizing the Lagrangian costs of bit rate and mean squared reconstruction error.

Summarizing, the method of this embodiment comprises the steps of determining a segmentation indicator for indicating whether segmentation is to be applied or not for either of block, slice, or sequence of video frames; and including the segmentation indicator into a coded bitstream including also the coded prediction signal. Hereinafter, the applications to the video coding method and the video decoding method described in each of embodiments and systems using thereof will be described.

FIG. 17 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 17, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital video camera, is capable of capturing both still images and video. Furthermore, the cellular phone ex114 may be the one that meets any of the standards such as Global System for Mobile Communications (GSM), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments, and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data.

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the image data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

Aside from the example of the content providing system ex100, at least one of the video coding apparatus and the video decoding apparatus described in each of embodiments may be implemented in a digital broadcasting system ex200 illustrated in FIG. 18. More specifically, a broadcast station ex201 communicates or transmits, via radio waves to a broadcast satellite ex202, multiplexed data obtained by multiplexing audio data and others onto video data. The video data is data coded by the video coding method described in each of embodiments. Upon receipt of the multiplexed data, the broadcast satellite ex202 transmits radio waves for broadcasting. Then, a home-use antenna ex204 with a satellite broadcast reception function receives the radio waves.

Next, a device such as a television (receiver) ex300 and a set top box (STB) ex217 decodes the received multiplexed data, and reproduces the decoded data.

Furthermore, a reader/recorder ex218 (i) reads and decodes the multiplexed data recorded on a recording media ex215, such as a DVD and a BD, or (i) codes video signals in the recording medium ex215, and in some cases, writes data obtained by multiplexing an audio signal on the coded data. The reader/recorder ex218 can include the video decoding apparatus or the video coding apparatus as shown in each of embodiments. In this case, the reproduced video signals are displayed on the monitor ex219, and can be reproduced by another device or system using the recording medium ex215 on which the multiplexed data is recorded. It is also possible to implement the video decoding apparatus in the set top box ex217 connected to the cable ex203 for a cable television or to the antenna ex204 for satellite and/or terrestrial broadcasting, so as to display the video signals on the monitor ex219 of the television ex300. The video decoding apparatus may be implemented not in the set top box but in the television ex300.

FIG. 19 illustrates the television (receiver) ex300 that uses the video coding method and the video decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively; and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

As an example, FIG. 20 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

FIG. 21 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 18. The same will be true for the configuration of the computer ex111, the cellular phone ex114, and others.

FIG. 22 (a) illustrates the cellular phone ex114 that uses the video coding method and the video decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 22 (b). In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350.

Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex356.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the video coding method shown in each of embodiments, and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method.

Then, the modulation/demodulation unit ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a video decoding method corresponding to the coding method shown in each of embodiments, and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the video coding method and the video decoding method in each of embodiments can be used in any of the devices and systems described. Thus, the advantages described in each of embodiments can be obtained.

Furthermore, the present invention is not limited to embodiments, and various modifications and revisions are possible without departing from the scope of the present invention.

Video data can be generated by switching, as necessary, between (i) the video coding method or the video coding apparatus shown in each of embodiments and (ii) a video coding method or a video coding apparatus in conformity with a different standard, such as MPEG-2, MPEG4-AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the video coding method and by the video coding apparatus shown in each of embodiments will be hereinafter described. The multiplexed data is a digital stream in the MPEG2-Transport Stream format.

FIG. 23 illustrates a structure of the multiplexed data. As illustrated in FIG. 23, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the video coding method or by the video coding apparatus shown in each of embodiments, or in a video coding method or by a video coding apparatus in conformity with a conventional standard, such as MPEG-2, MPEG4-AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary video to be mixed with the primary audio.

FIG. 24 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

FIG. 25 illustrates how a video stream is stored in a stream of PES packets in more detail. The first bar in FIG. 25 shows a video frame stream in a video stream. The second bar shows the stream of PES packets. As indicated by arrows denoted as yy1, yy2, yy3, and yy4 in FIG. 25, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

FIG. 26 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 26. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

FIG. 27 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

Each of the multiplexed data information files is management information of the multiplexed data as shown in FIG. 28. The multiplexed data information files are in one to one correspondence with the multiplexed data, and each of the files includes multiplexed data information, stream attribute information, and an entry map.

As illustrated in FIG. 28, the multiplexed data includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

As shown in FIG. 29, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

The multiplexed data to be used is of a stream type included in the PMT. Furthermore, when the multiplexed data is recorded on a recording medium, the video stream attribute information included in the multiplexed data information is used. More specifically, the video coding method or the video coding apparatus described in each of embodiments includes a step or a unit for allocating unique information indicating video data generated by the video coding method or the video coding apparatus in each of embodiments, to the stream type included in the PMT or the video stream attribute information. With the configuration, the video data generated by the video coding method or the video coding apparatus described in each of embodiments can be distinguished from video data that conforms to another standard.

Furthermore, FIG. 30 illustrates steps of the video decoding method. In Step exS100, the stream type included in the PMT or the video stream attribute information is obtained from the multiplexed data. Next, in Step exS101, it is determined whether or not the stream type or the video stream attribute information indicates that the multiplexed data is generated by the video coding method or the video coding apparatus in each of embodiments. When it is determined that the stream type or the video stream attribute information indicates that the multiplexed data is generated by the video coding method or the video coding apparatus in each of embodiments, in Step exS102, decoding is performed by the video decoding method in each of embodiments. Furthermore, when the stream type or the video stream attribute information indicates conformance to the conventional standards, such as MPEG-2, MPEG4-AVC, and VC-1, in Step exS103, decoding is performed by a video decoding method in conformity with the conventional standards.

As such, allocating a new unique value to the stream type or the video stream attribute information enables determination whether or not the video decoding method or the video decoding apparatus that is described in each of embodiments can perform decoding. Even when multiplexed data that conforms to a different standard, an appropriate decoding method or apparatus can be selected. Thus, it becomes possible to decode information without any error. Furthermore, the video coding method or apparatus, or the video decoding method or apparatus can be used in the devices and systems described above.

Each of the video coding method, the video coding apparatus, the video decoding method, and the video decoding apparatus in each of embodiments is typically achieved in the form of an integrated circuit or a Large Scale Integrated (LSI) circuit. As an example of the LSI, FIG. 31 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream 10 ex506 provides the multiplexed data outside. The provided multiplexed data is transmitted to the base station ex107, or written on the recording media ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex510 includes the CPU ex502, the memory controller ex503, the stream controller ex504, the driving frequency control unit ex512, the configuration of the control unit ex510 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

When video data generated in the video coding method or by the video coding apparatus described in each of embodiments is decoded, compared to when video data that conforms to a conventional standard, such as MPEG-2, MPEG4-AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

In order to solve the problem, the video decoding apparatus, such as the television ex300 and the LSI ex500 is configured to determine to which standard the video data conforms, and switch between the driving frequencies according to the determined standard. FIG. 32 illustrates a configuration ex800. A driving frequency switching unit ex803 sets a driving frequency to a higher driving frequency when video data is generated by the video coding method or the video coding apparatus described in each of embodiments. Then, the driving frequency switching unit ex803 instructs a decoding processing unit ex801 that executes the video decoding method described in each of embodiments to decode the video data. When the video data conforms to the conventional standard, the driving frequency switching unit ex803 sets a driving frequency to a lower driving frequency than that of the video data generated by the video coding method or the video coding apparatus described in each of embodiments. Then, the driving frequency switching unit ex803 instructs the decoding processing unit ex802 that conforms to the conventional standard to decode the video data.

More specifically, the driving frequency switching unit ex803 includes the CPU ex502 and the driving frequency control unit ex512 in FIG. 31. Here, each of the decoding processing unit ex801 that executes the video decoding method described in each of embodiments and the decoding processing unit ex802 that conforms to the conventional standard corresponds to the signal processing unit ex507 in FIG. 31. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described is probably used for identifying the video data. The identification information is not limited to the one described above but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 34. The driving frequency can be selected by storing the look-up table in the buffer ex508 and in an internal memory of an LSI, and with reference to the look-up table by the CPU ex502.

FIG. 33 illustrates steps for executing a method. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the video coding method and the video coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG4-AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the video coding method and the video coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG 4-AVC is larger than the processing amount for decoding video data generated by the video coding method and the video coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the video coding method and the video coding apparatus described in each of embodiments, the voltage to be applied to the LSI ex500 or the apparatus including the LSI ex500 is probably set higher. When the identification information indicates that the video data conforms to the conventional standard, such as MPEG-2, MPEG4-AVC, and VC-1, the voltage to be applied to the LSI ex500 or the apparatus including the LSI ex500 is probably set lower. As another example, when the identification information indicates that the video data is generated by the video coding method and the video coding apparatus described in each of embodiments, the driving of the CPU ex502 does not probably have to be suspended. When the identification information indicates that the video data conforms to the conventional standard, such as MPEG-2, MPEG4-AVC, and VC-1, the driving of the CPU ex502 is probably suspended at a given time because the CPU ex502 has extra processing capacity. Even when the identification information indicates that the video data is generated by the video coding method and the video coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG4-AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

There are cases where a plurality of video data that conforms to different standards, is provided to the devices and systems, such as a television and a mobile phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

In order to solve the problem, what is conceived is a configuration in which the decoding processing unit for implementing the video decoding method described in each of embodiments and the decoding processing unit that conforms to the conventional standard, such as MPEG-2, MPEG4-AVC, and VC-1 are partly shared. Ex900 in FIG. 35(a) shows an example of the configuration. For example, the video decoding method described in each of embodiments and the video decoding method that conforms to MPEG4-AVC have, partly in common, the details of processing, such as entropy coding, inverse quantization, deblocking filtering, and motion compensated prediction. The details of processing to be shared probably includes use of a decoding processing unit ex902 that conforms to MPEG4-AVC. In contrast, a dedicated decoding processing unit ex901 is probably used for other processing unique to the present invention. Since the present invention is characterized by a spatial prediction, for example, the dedicated decoding processing unit ex901 is used for spatial prediction in accordance with the present invention. Otherwise, the decoding processing unit is probably shared for one of the entropy coding, inverse transformation, inverse quantization, and motion compensated prediction, or all of the processing. The decoding processing unit for implementing the video decoding method described in each of embodiments may be shared for the processing to be shared, and a dedicated decoding processing unit may be used for processing unique to that of MPEG4-AVC.

Furthermore, ex1000 in FIG. 35(b) shows another example in that processing is partly shared. This example uses a configuration including a dedicated decoding processing unit ex1001 that supports the processing unique to the present invention, a dedicated decoding processing unit ex1002 that supports the processing unique to another conventional standard, and a decoding processing unit ex1003 that supports processing to be shared between the video decoding method in the present invention and the conventional video decoding method. Here, the dedicated decoding processing units ex1001 and ex1002 are not necessarily specialized for the processing of the present invention and the processing of the conventional standard, respectively, and may be the ones capable of implementing general processing. Furthermore, the configuration can be implemented by the LSI ex500.

As such, reducing the scale of the circuit of an LSI and reducing the cost are possible by sharing the decoding processing unit for the processing to be shared between the video decoding method in the present invention and the video decoding method in conformity with the conventional standard.

Most of the examples have been outlined in relation to an H.264/AVC based video coding system, and the terminology mainly relates to the H.264/AVC terminology. However, this terminology and the description of the various embodiments with respect to H.264/AVC based coding is not intended to limit the principles and ideas of the invention to such systems. Also the detailed explanations of the encoding and decoding in compliance with the H.264/AVC standard are intended to better understand the exemplary embodiments described herein and should not be understood as limiting the invention to the described specific implementations of processes and functions in the video coding. Nevertheless, the improvements proposed herein may be readily applied in the video coding described. Furthermore the concept of the invention may be also readily used in the enhancements of H.264/AVC coding and/or HEVC currently discussed by the JCT-VC.

Summarizing, the present invention relates to block-wise coding and decoding of a video signal including at least two color components. The first component is coded by using prediction and the second component is segmented to different parts used for its coding according to the prediction error.

1. A method for encoding at least two color components of a video signal comprising:
encoding a block of a first color component using predictive coding;
deriving a block division for the encoding of another color component based on the prediction error of said first color component.

2. The method of claim 1, wherein
the block division is derived based on a threshold operation comparing the prediction error signal with a predetermined threshold.

3. The method of claim 2, wherein
the prediction error signal compared is a DC coefficient of subblocks of said block of the first color component transformed into frequency domain.

4. The method of claim 2, wherein
the prediction error signal is either quantized prediction error signal or transformed and quantized prediction error signal on pixel positions of the block of the first component.

5. The method of claim 2, wherein:
the block of the second component, corresponding with position to the block of the first component, is subdivided into two parts according to the thresholding operation result;
and
the two parts are predicted differently.

6. The method according to claim 5, further comprising:
coding the two parts of the block of the second color component based on their respective prediction; and
deriving a block division for the encoding of a third color component based on the prediction error of said second color component.

7. The method according to claim 1, further comprising:
determining a segmentation indicator for indicating whether segmentation is to be applied or not for either of block, slice, or sequence of video frames; and
including the segmentation indicator into a coded bitstream including also the coded prediction signal.

8. A method for decoding at least two color components of a video signal comprising:
decoding of a block of a first color component using predictive coding; and
deriving a block division for the decoding of another color component based on the prediction error of said first color component.

9. The method of claim 8, wherein
the block division is derived based on a threshold operation comparing the prediction error signal with a predetermined threshold.

10. The method of claim 9, wherein
the prediction error signal compared is a DC coefficient of subblocks of said block of the first color component transformed into frequency domain.

11. The method of claim 9, wherein
the prediction error signal is either quantized prediction error signal or transformed and quantized prediction error signal on pixel positions of the block of the first component.

12. The method of claim 9, wherein:
the block of the second component, corresponding with position to the block of the first component, is subdivided into two parts according to the thresholding operation result; and
the two parts are predicted differently.

13. The method according to claim 12, further comprising:
decoding the two parts of the block of the second color component based on their respective prediction; and
deriving a block division for the decoding of a third color component based on the prediction error of said second color component.

14. The method according to claim 8, further comprising:
extracting a segmentation indicator from a coded bitstream including also the coded prediction signal; and
determining whether to segment the block of a color component in accordance with the extracted segmentation indicator.

15. A non-transitory computer-readable medium for use in a computer, the non-transitory recording medium having a computer-readable program recorded thereon for causing the computer to carry out the method according to claim 1.

16. An encoding apparatus for encoding at least two color components of a video signal comprising:
an encoding means for encoding a block of a first color component using predictive coding; and
a means for deriving a block division for the encoding of another color component based on the prediction error of said first color component.

17-22. (canceled)

23. A decoding apparatus comprising:
a decoding unit configured to decode a block of a first color component using predictive coding; and
a deriving unit configured to derive a block division for the decoding of another color component based on the prediction error of said first color component.

24-29. (canceled)

30. A non-transitory computer-readable medium for use in a computer, the non-transitory recording medium having a computer-readable program recorded thereon for causing the computer to carry out the method according to claim 8.
